(19) United States
(12) Patent Application Publication
(10) Pub. No.: US 2005/0171965 A1
(43) Pub. Date: Aug. 4, 2005

(54) Contents reuse management apparatus and contents reuse support apparatus

(75) Inventors: Taro Fujimoto, Kawasaki (JP); Jun Arima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/093,090

(22) Filed: Mar. 30, 2005

Related U.S. Application Data
(63) Continuation of application No. PCT/JP03/07019, filed on Jun. 3, 2003.

(30) Foreign Application Priority Data
Oct. 10, 2002 (JP) 2002-296862

(51) Int. Cl. G06F 7/00

(52) U.S. Cl. 707/100

(57) ABSTRACT

A contents reuse management apparatus judges the presence/absence of a reuse relationship among contents stored in a database using a computer, includes a surface information generation unit to generate surface information including a character string appearing in the contents, and a reuse judging unit to judge the reusability using the surface information, and judges the presence/absence of the reuse relationship among the contents based on the matching level of the surface information among the contents.

### CROSS REFERENCE TO RELATED APPLICATIONS

This is a continuation application of PCT application No.PCT/JP03/07019 filed on Jun. 3, 2003 in Japan.

### BACKGROUND OF THE INVENTION

1. Field of the Invention

This invention relates to a contents reuse management apparatus and a contents reuse support apparatus, and more particularly to a contents reuse management apparatus and a contents reuse support apparatus for judging the level of the reuse among contents stored in a database using a computer such as a scenario, text, a document, a template, a sentence example, a drawing example, an image, voice, etc. The contents reuse management apparatus according to the present invention judges the reusability of the contents from the surface information about contents, a keyword, etc., and obtains the presence/absence of a reuse relationship and the level of reuse from the contents similarity and the information associated with the contents. The contents reuse support apparatus according to the present invention provides a user with recommendation information indicating the importance level of contents based on the level of the reuse of contents, and allows the contents at a high importance level to be easily selected, thereby supporting easy reuse of contents.

2. Description of the Related Art

The similarity between contents has conventionally been judged by the number of appearance times of keywords, etc. But, it has not been checked whether the keywords incidentally appear in both documents or the keywords appear by reuse in both documents.

The similarity can also be judged by extracting the longest matching character string from two documents.

Further Japanese Patent Application Laid-Open No. 2002-118736 (pages 7 to 11) describes that a replica is checked by electronic watermark.

Conventionally, a binary judgment has been performed using “YES” and “NO” to check the reuse of contents including a document, an image, voice, etc. in the method including electronic watermark. However, this method requires a complicated process of specifically inserting electronic watermark.

### SUMMARY OF THE INVENTION

Therefore, it is an object of the present invention to provide a contents reuse management apparatus which can promote and control the reuse of contents by determining the level of the reuse according to surface information including a text string, a byte string, etc. about the contents of a text document, an image document, etc. and the pattern information using a dictionary, without using the above-mentioned electronic watermark, and by grasping derivative relationship between contents.

Furthermore, it is an object of the present invention to provide a contents reuse support apparatus for supporting the reuse of contents by judging level of the reuse of contents, generating contents recommendation information based on the level of the reuse, and providing a user with the information, thereby allowing the user to easily selecting contents at a high importance level.

The present invention provides a contents reuse management apparatus for judging the presence/absence of reuse between contents. The apparatus includes a surface information generation unit to generate surface information including a character string, etc. appearing in the contents, and a reuse judging unit to judge the reusability using the surface information. And, the presence/absence of the use relationship between the contents is judged according to the matching level of the surface information between the contents.

The present invention provides also a contents reuse management apparatus for judging the presence/absence of reuse between contents. The apparatus includes reuse judging unit to generate a keyword contained in the contents and to judge the reusability based on the keyword. And, the presence/absence of the use relationship between the contents is judged according to the matching level of the keyword between the contents.

Furthermore, the present invention provides a contents reuse management apparatus for judging the presence/absence of reuse between contents. The apparatus includes a surface information generation unit to generate surface information including a character string appearing in contents, at least one of reuse judging unit to judge the presence/absence of a reuse relationship between contents according to the surface information and reuse judging unit to judge reusability based on a keyword, a meta-data holding unit to hold meta-data which is attribute information about contents, and meta-data use judging unit to support a judging result of the reuse judging unit using the meta-data. And, the reuse is further judged based on the reuse judgment result of the reuse judging unit and the meta-data.

The present invention provides a contents reuse management apparatus including first contents to be referred and being able to be reused, second contents to be judged which can be generated by reusing the contents to be referred, a surface information generation unit to generate surface information including a character string appearing in contents, etc., a reuse judging unit having a surface information base reuse judging engine to judge reusability according to the surface information, and a display unit to display information output by the reuse judging unit.

Thus, when there are two contents, surface information can be generated using these contents, and the reuse relationship can be checked by matching the surface information. Therefore, a reuse status can be detected without a complicated process including electronic watermark, or without preparing information including a keyword, meta-data, etc. in advance.

The contents reuse management apparatus according to the present invention includes first contents to be referred and being able to be reused, second contents to be judged which can be generated by reusing the first contents to be referred, a reuse judging unit having a keyword dictionary to hold a keyword, a character string, etc. and a dictionary base reuse judging engine to judge the reusability according to dictionary information about a keyword, a character string, etc., and a display unit to display information output by the reuse judging unit.

Thus, since it is not necessary to extract a pattern from contents, a reuse relationship can be quickly detected.

The contents reuse management apparatus according to the present invention includes first contents to be referred and being able to be reused, meta-data including a generating person, a backup source, etc. of the first contents to be referred, second contents to be judged which can be generated by reusing the first contents to be referred, meta-data relating to the second contents to be judged, a surface information generation unit to generate surface information including a character string, etc. appearing in the contents, a reuse judging unit having a surface information base reuse judging engine to judge the reusability using surface information, or reuse judging unit having a keyword dictionary to hold a keyword, a character string, etc. and a dictionary base reuse judging engine to judge the reusability according to dictionary information including a keyword, a character string, etc., a judgment support unit to support a judgment result of the reuse judging unit using meta-data, a meta-information dictionary to hold meta-data used by the judgment support unit, and a display unit to display information output by the reuse judging unit.

Since meta-data is used in addition to surface information about contents and keyword information, a correct reuse judgment can be made at a higher level by judging a strong possibility of reuse when the same user generates two documents.

Furthermore, the contents reuse management apparatus according to the present invention includes a reference contents database to store a plurality of first contents to be referred and being able to be reused, second contents to be judged which can be generated by reusing first contents stored in the reference contents database, a surface information generation unit to generate surface information including a character string, etc. appearing in the contents, a reuse judging unit having a surface information base reuse judging engine to judge the reusability using the surface information, or reuse judging unit having a keyword dictionary to hold a keyword, a character string, etc. and a dictionary base reuse judging engine to judge the reusability according to the dictionary information including the keyword, a character string, etc., and a display unit to display information output by the reuse judging unit.

Since a database stores a plurality of contents to make a judgment, all contents in a company, all contents in the departments of a company or a plurality of contents can be matched with. Thus, a judgment can be more quickly made as to which contents are reused for contents to be judged in the company than by matching with each contents.

The contents reuse management apparatus according to the present invention includes a reference contents database with meta-data to store a plurality of first contents to be referred and being able to be reused and first meta-data of the first contents, second contents to be judged which can be generated by reusing first contents stored in the reference contents database with meta-data, second meta-data relating to the second contents to be judged, a surface information generation unit to generate surface information including a character string, etc. appearing in contents, a reuse judging unit having a surface information base reuse judging engine to judge the reusability using surface information, or reuse judging unit having a keyword dictionary to hold a keyword, a character string, etc. and a dictionary base reuse judging engine to judge the reusability according to the dictionary information including the keyword, a character string, etc., a judgment support unit to support a judgment result of the reuse judging unit using third meta-data, a meta-information dictionary to hold the third meta-data used by the judgment support unit, and a display unit to display information output by the reuse judging unit.

Since meta-data of the respective contents is stored in addition to the plurality of contents in the database, a reuse relationship can be correctly judged using both of the plurality of contents and meta-data.

The contents reuse support apparatus according to the present invention includes a contents holding unit to hold contents, a contents management unit to manage management information indicating the level of reuse of the contents, and a contents recommendation unit to generate contents recommendation information for recommendation of contents according to the contents use information.

The contents reuse support apparatus according to the present invention includes a contents generation support unit to support a user editing contents according to recommendation information generated by a contents recommendation unit.

According to the above-mentioned contents reuse support apparatus of the present invention, contents having a high use rate can be easily selected, and thus the contents can be reused.

### BRIEF DESCRIPTION OF THE DRAWINGS

FIG. 1 shows the first embodiment of the present invention.

FIG. 2 is an explanatory view of generating a matching character string and a keyword.

FIG. 3 shows the structure of the system of the contents reuse management apparatus according to the present invention.

FIG. 4 shows the structure of the reuse judging unit according to the present invention.

FIG. 5 is a flowchart of generating a matching character string according to the first embodiment of the present invention.

FIG. 6 is a flowchart of a reuse judgment according to the first embodiment of the present invention.

FIG. 7 is another flowchart of a reuse judgment according to the first embodiment of the present invention.

FIG. 8 shows the second embodiment of the present invention.

FIG. 9 shows the structure of the reuse judging unit according to the second embodiment of the present invention.

FIG. 10 is a flowchart of a reuse judgment according to the second embodiment of the present invention.

FIG. 11 is a flowchart of a reuse judgment using a special keyword of the reuse judging unit according to the present invention.

FIG. 12 shows the third embodiment of the present invention.

FIG. 13 shows the structure of the reuse judging unit according to the third embodiment of the present invention.

FIG. 14 is a flowchart of the reuse judging unit according to the third embodiment of the present invention.

FIG. 15 shows the fourth embodiment of the present invention.

FIG. 16 shows the structure of the reuse judging unit according to the fourth embodiment of the present invention.

FIG. 17 is a flowchart of the reuse judging unit according to the fourth embodiment of the present invention.

FIG. 18 shows the fifth embodiment of the present invention.

FIG. 19 shows the structure of the reuse judging unit according to the fifth embodiment of the present invention.

FIGS. 20A and 20B are flowcharts (1) and (2) of the reuse judging unit according to the fifth embodiment of the present invention.

FIG. 21 is a flowchart (3) according to the fifth embodiment of the present invention.

FIG. 22 shows the sixth embodiment of the present invention.

FIG. 23 is an explanatory view of the operation according to the sixth embodiment of the present invention.

FIG. 24 shows the structure of the system of the contents reuse support apparatus according to the present invention.

FIG. 25 shows the structure of the contents reuse support apparatus according to the present invention.

FIG. 26 shows the structure of the contents database according to the present invention.

FIG. 27 shows an example of the scenario according to the present invention.

FIG. 28 shows an example of the template according to the present invention.

FIG. 29 is an explanatory view of the original contents and the derivative relationship according to the present invention.

FIG. 30 is an explanatory view of the retrieval result of the contents reuse relationship, the reference contents display, and the derivative contents display according to the present invention.

FIG. 31 is an explanatory view of the operation of the contents reuse support apparatus according to the present invention.

FIG. 32 is a flowchart of the recommendation information generation unit of the contents recommendation unit according to the present invention.

FIGS. 33A and 33B are a flowchart of the retrieval result of generating a contents reuse relationship and a flowchart of generating reference contents display information.

FIG. 34 is a flowchart of derivative contents display according to the present invention.

FIG. 35 shows the structure of the draft generation support unit according to the present invention.

FIGS. 36A and 36B are a flowchart of the process of editing contents of the draft generation support unit and a flowchart of the difference extraction unit of the draft generation support unit.

FIG. 37 shows the structure and the operation of the contents parts segmentation support unit according to the present invention.

FIGS. 38A and 38B is a flowchart of the common point obtaining unit of the contents parts segmentation support unit and a flowchart of the contents boundary information generation unit according to the present invention.

FIG. 39 shows an example of the common point extracted according to the present invention.

FIGS. 40A and 40B are a flowchart of the contents parts management unit of the contents management support unit and a flowchart of generating contents parts according to the present invention.

FIG. 41 shows an example of a system which is structured by the contents reuse management apparatus and the contents generation support apparatus according to the present invention.

### DETAILED DESCRIPTION OF THE PREFERRED EMBODIMENTS

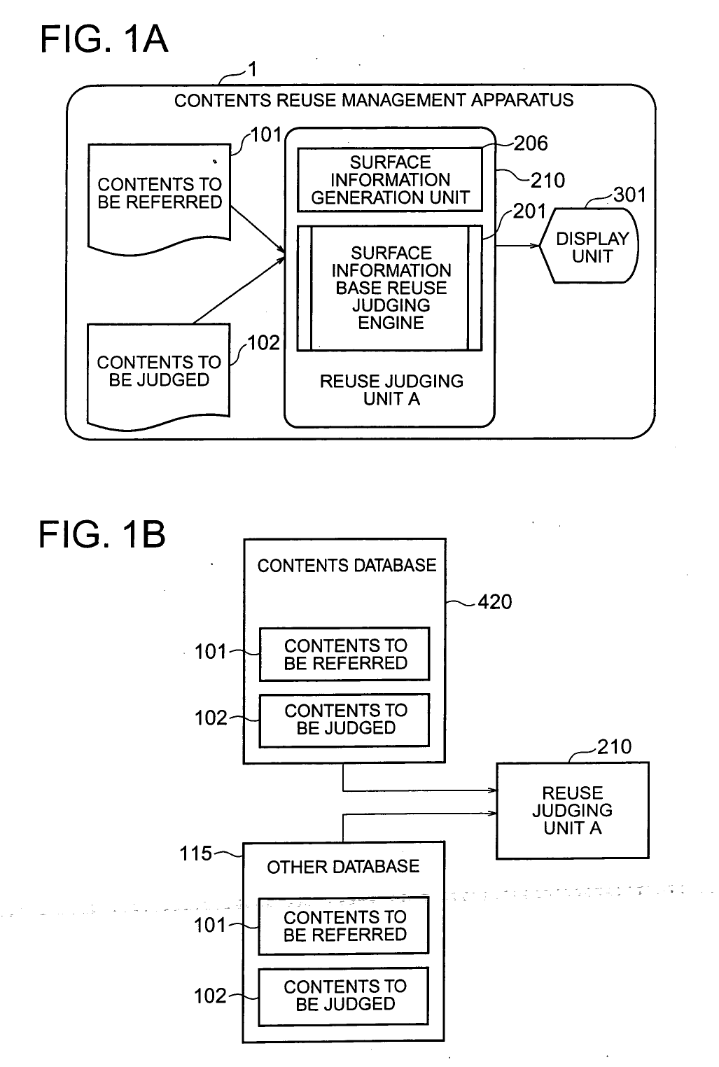

The first embodiment of the present invention is explained below by referring to FIG. 1. In FIG. 1A, a contents reuse management apparatus 1 comprises contents 101 to be referred, contents 102 to be judged, a surface information base reuse judging engine 201, surface information generation unit 206, reuse judging unit A 210, and a display unit 301.

FIG. 1B shows a database to be accessed by the reuse judging unit 210. In FIG. 1B, a contents database 420 is used by the contents reuse management apparatus according to the present invention. A database 115 stores other common contents to be managed. The contents reuse management apparatus according to the present invention can process the contents 101 to be referred and the contents 102 to be judged which are stored in the respective databases.

In FIG. 1A, the contents reuse management apparatus 1 judges according to the surface information whether or not the contents 102 to be judged have been generated by reusing the contents 101 to be referred.

It is judged whether or not the contents 101 to be referred have been reused to generate other contents. It is also judged whether or not the contents 102 to be judged have been generated by reusing other contents. FIG. 1A shows the state of judging whether or not the contents 102 to be judged have been generated by reusing the contents 101 to be referred.

The surface information base reuse judging engine 201 judges using the surface information about the contents 101 to be referred and the contents 102 to be judged whether or not the contents 102 to be judged have been generated by reusing the contents 101 to be referred, and is structured by the CPU.

The surface information generation unit 206 generates surface information including a character string (including a punctuation mark) appearing in the contents 101 to be referred and the contents 102 to be judged. In other words, the unit 206 generates a text string or a byte string of a text document and an image document.

The reuse judging unit 210 judges according to the surface information whether or not the contents 102 to be judged have been generated by reusing the contents 101 to be referred. In other words, the unit 210 obtains such judgment results as (1) totally reused, (2) partially reused, (3) possibly referred to, and (4) no possibility of reuse, etc.

The judgment (1) indicates the case in which the surface information about the contents 102 to be judged substantially matches the surface information about the contents 101 to be referred in the entire contents. The judgment (2) indicates the case in which the surface information about the contents 102 to be judged substantially matches the surface information about the contents 101 to be referred in, for example, the first half portion or the second half portion. The judgment (3) indicates the case in which the surface information matches in the certain number of pieces of data or in a certain length. The judgment (4) indicates the case in which none of the judgments (1) to (3) obtained. The substantially matching level in the judgment (1), the partially matching level in the judgment (2), the certain number or a threshold of a length in the judgment (3) are predetermined. When a plurality of surface information are matched, it is necessary in judging the reusability that the order of the portions of the matched surface information is the same.

The display unit 301 displays the judgment result of the reuse judging unit 210 as indicated by, for example, the judgments (1) to (4), and the user can judge the reuse status of the contents 102 to be judged to the contents 101 to be referred.

Described below is the operation shown in FIG. 1A. When it is judged whether or not the contents 102 to be judged is obtained by reusing the contents 101 to be referred, the reuse judging unit 210 operates to firstly read the contents 101 to be referred. Then the surface information generation unit 206 interprets the contents, generates the surface information about them and holds the information. The unit 206 then reads the contents 102 to be judged, interprets them, generates the surface information about the contents, and holds the information.

Then, the surface information base reuse judging engine 201 operates to sequentially compare the surface information about the contents 101 to be referred with the surface information about the contents 102 to be judged, and sequentially discriminates the matching portion. When there is matching surface information and there are a plurality of matching portions, it is further judged whether or not the matching portions also match in order, and at which positions of the contents 102 to be judged the matching occurs.

Based on the judgment, the surface information base reuse judging engine 201 outputs the judgment results of the judgments (1) to (4), and displays the results on the display unit 301.

By watching the display, the user can recognize whether or not the contents 102 to be judged is obtained by reusing the contents 101 to be referred.

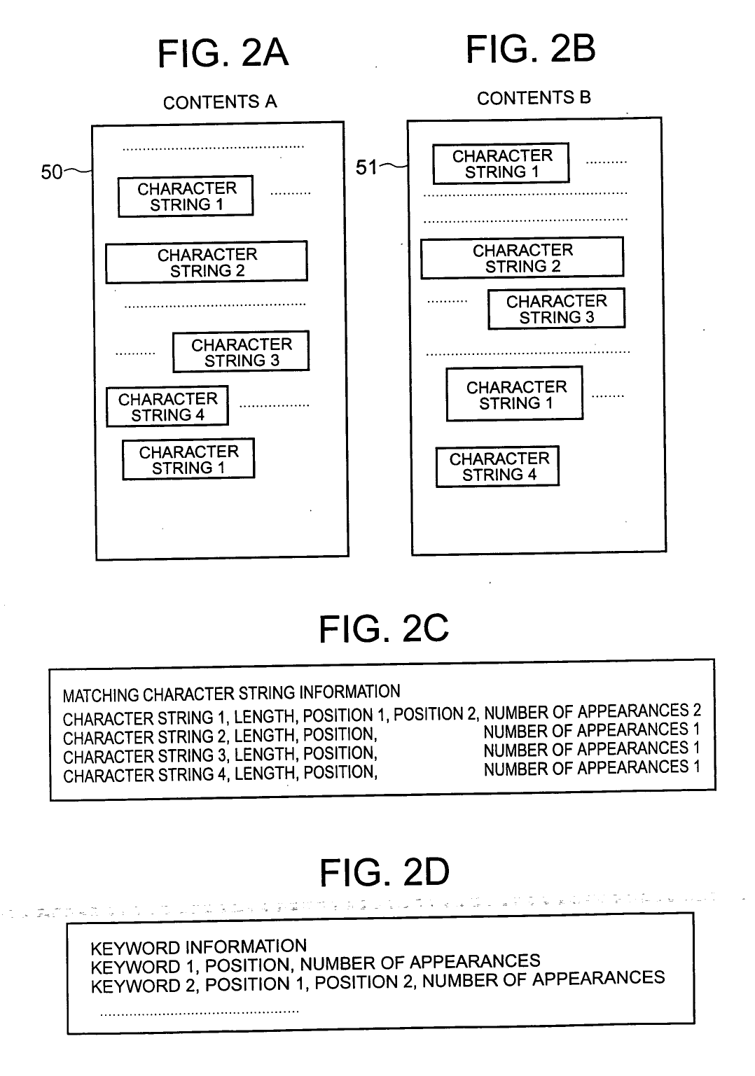

FIGS. 2A and 2B are explanatory views of a matching character string and a keyword between two contents. There are contents A 50 and contents B 51. FIG. 2 shows that characters strings 1, 2, 3, and 4 match in the character strings of the contents A and B. For example, when the matching character string 1 appears two times, the matching character string management information is held as a length of a character string, the appearance positions 1 and 2, the number of appearances 2 as associated with the matching character string 1.

FIG. 2C shows matching character string management information including, for example, a matching character string associated with its length, an appearance position, and the number of appearances. When the same matching character string is generated, the matching character string and the associated position (appearance position 1, 2, etc.) and number of appearances are stored for each appearance. The appearance position is, for example, represented by the number of characters, etc. from the leading character of the contents.

FIG. 2D shows the keyword information for use in judging the reuse of contents using a keyword, and held with the keyword associated with its appearance position. When the same keyword appears a plurality of times, the keyword is held with the appearance positions and the number of appearances.

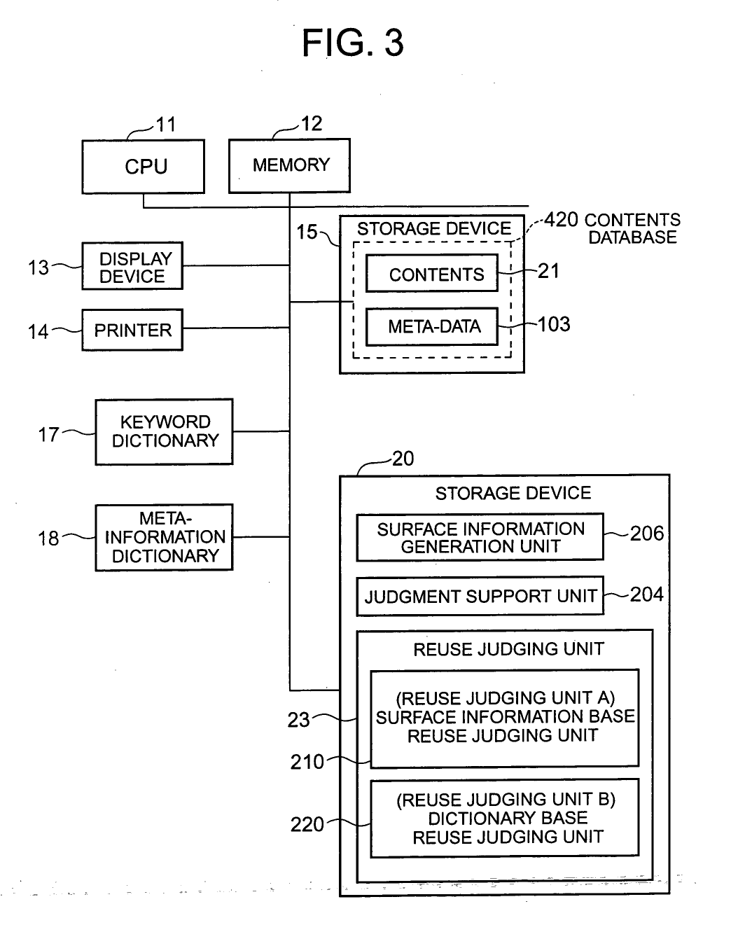

FIG. 3 shows the structure of the system of the contents reuse management apparatus according to the present invention. In FIG. 3, the apparatus comprises a CPU 11, memory 12, a display device 13, a printer 14, a storage device 15 for holding contents, a storage device 20 for holding various programs for embodying the present invention, a keyword dictionary 17, and a meta-information dictionary 18 for holding meta-information including the departments of a company, the projects, and the names of the members of the departments.

The storage device 15 comprises the contents database 420 comprising a contents 21 and meta-data 103 about the generation date, the generating person, etc. of the contents. A reference numeral 106 denotes a contents database. The storage device 20 comprises the surface information generation unit 206 for generating a character string of contents, judgment support unit 204 for judging reuse of contents using a meta-information dictionary, and reuse judging unit 23 for judging the presence/absence of reuse of contents.

The reuse judging unit 23 comprises the reuse judging unit A 210 which is surface information base reuse judging unit to judge reuse of contents according to surface information, and reuse judging unit B 220 which is a dictionary base reuse judging unit and makes a reuse judgment using a keyword dictionary.

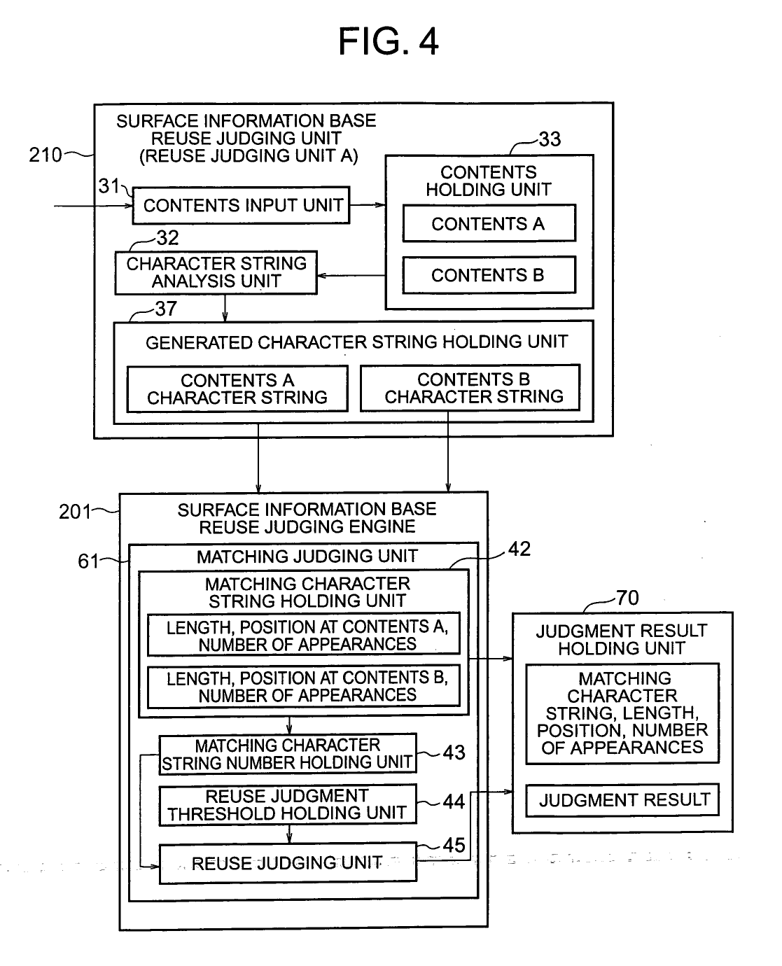

FIG. 4 shows the structure of the reuse judging unit according to the present invention. The reuse judging unit 210 (the same as the reuse judging unit 210 shown in FIG. 1) is surface information base reuse judging unit. The surface information base reuse judging engine 201 is a surface information base reuse judging engine.

The reuse judging unit 210 comprises a contents input unit 31 for inputting contents, a character string analysis unit 32 for analyzing a character string of contents, a contents holding unit 33 for holding an input contents, and a generated character string holding unit 37 for holding a generated character string.

The surface information base reuse judging engine 201 comprises a matching judging unit 61 for judging match between the character strings of the contents A and B and holding a matching character string with a matching character string length, the positions and number of appearances of the matching character strings in the contents A and B, a matching character string holding unit 42 for holding a matching character string, a matching character string number holding unit 43, a reuse judgment threshold holding unit 44 for holding a character for a reuse judgment and holding a matching character threshold for a judgment of matching, a threshold for appearance order matching of a character string, etc., and a reuse judging unit 45 for judging the level of contents reuse relationship by the number of matching character strings and the threshold, the number of matching appearance orders of matching character strings and the threshold, etc. A judgment result holding unit 70 holds the presence/absence of a contents reuse relationship and the reuse level, etc. for each content.

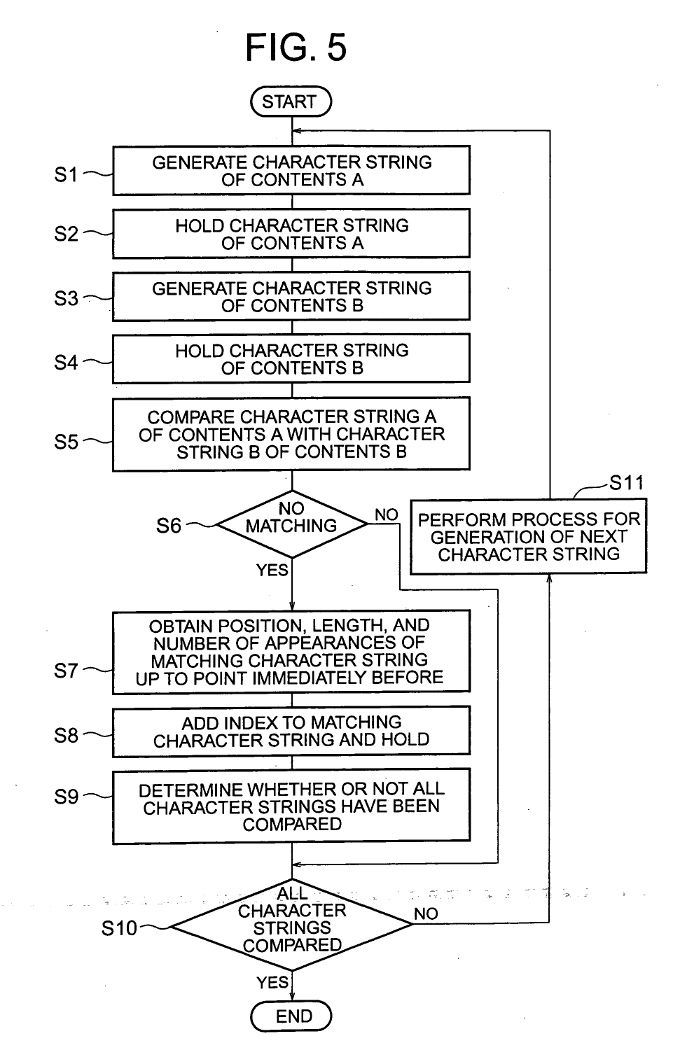

FIG. 5 is a flowchart of generating a matching character string according to the first embodiment of the present invention, and shows an example of generating a matching character string, but the present invention can be realized by other methods.

A character string of contents A is generated and held (S1 and S2), and a character string of contents B is generated and held (S3 and S4). A character string of the contents A is compared with a character string of the contents B (S5 and S6). When no matching is detected, the preceding matching character string is held with the length of its character string, the appearance position, the number of appearances, and an index (S7 and S8). It is determined whether or not all data is processed (S10). When YES, the process terminates. When NO, the process for generating the next character string is performed (S11), and the processes in and after S1 are repeated. When no matching character string is detected in S6, it is determined whether or not all character strings have been checked (S10). When YES, the process terminates. When NO, the process of generating the next character string is performed (S11), and the processes in and after S1 are repeated.

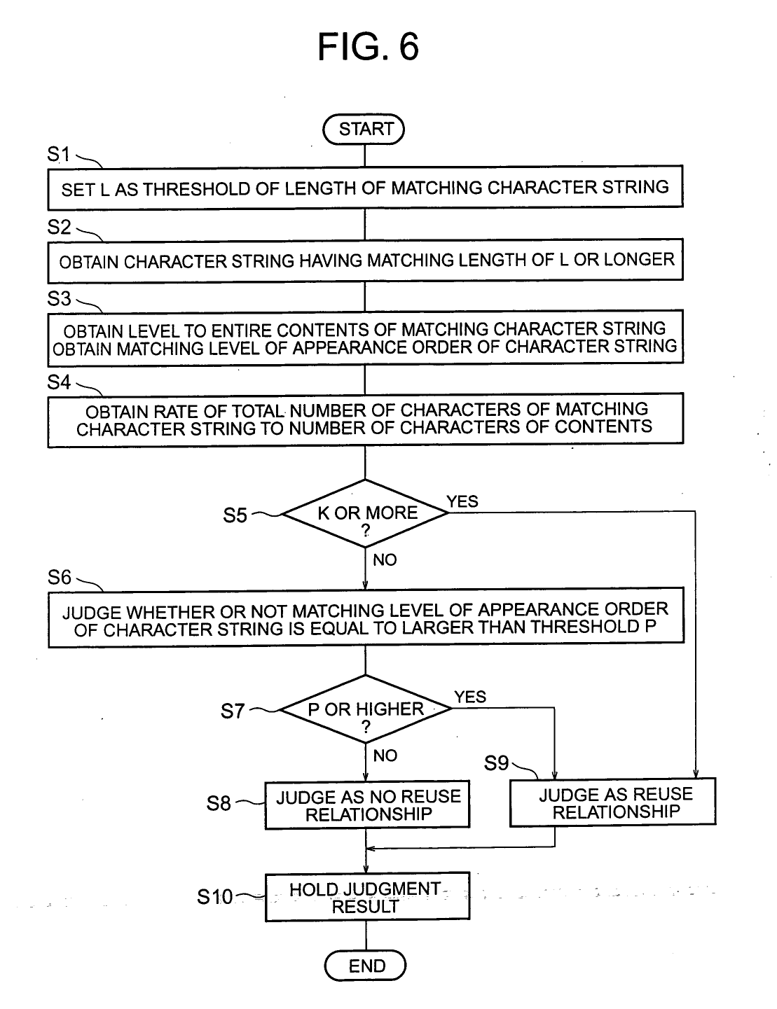

FIG. 6 is a flowchart of a reuse judgment according to the first embodiment of the present invention. The presence/absence of reuse is judged by, for example, the ratio of the total number of characters of a matching character string to the total number of characters of contents. Furthermore, when the ratio does not exceed a predetermined level, the number of character strings matching in appearance order is judged, and the level of the presence/absence of the use relationship is judged depending on the rate of the number of character strings matching in appearance order.

A value of L is set as a threshold of the length of a matching character string (S1). A character string exceeding L in length of a matching character string is obtained (S2). The ratio of the matching character string to the entire contents and the matching level of the appearance order of the matching character string are obtained (S3). The ratio of the total number of characters of a matching character string to the total number of characters of contents is obtained and is compared with the threshold (S4 and S5). When the rate of the number of characters of a matching character string exceeds K, it is judged that there is a reuse relationship between the contents A and the contents B. When the rate of the number of characters of a matching character string does not exceed K, the level of matching in appearance order of character strings is compared with the contents A and B (S6 and S7). The matching number or rate of the appearance order of a matching character string is obtained from the appearance position and the number of appearances of a matching character string, and when the value exceeds the threshold P, it is judged as “reuse relationship” (S9). When the rate of matching in the appearance order of a character string does not exceed the threshold P, it is judged as “no reuse relationship” (S8). Then, the judgment result is held (S10).

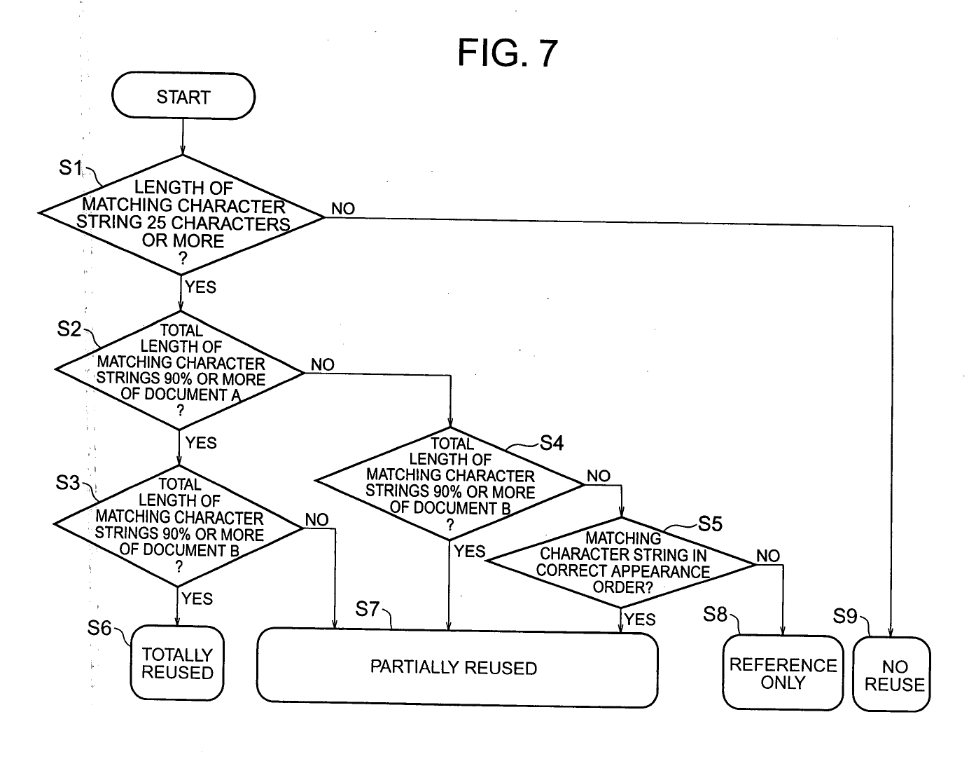

FIG. 7 shows an example of the judgment of reuse according to the first embodiment of the present invention. In FIG. 7, the threshold of the number of matching character strings is set to 25 characters, and “totally used” is judged when the rate of the number of matching character string (ratio of the total number of characters of a matching character string to the total number of characters of contents) between the contents A and B exceeds 90%. When at least one of the contents A and B exceeds 90%, it is judged as “partially reused” (in FIG. 7, the contents are explained as a document). Furthermore, when the rate of the total number of matching character strings of one of the contents is 90% or less, the appearance order of a matching character string is judged, and when the appearance order of a character string matches, then it is judged as “partial reuse relationship”. When there is no matching in appearance order, it is judged that “one has referred to the other just for information”. When there is no matching character string within 25 characters, it is judged as “no reuse”.

It is judged whether or not the length of a matching character string exceeds 25 characters (S1). When there is no matching within 25 characters, it is judged “no reuse” (S9). In the contents A (in contents A shown in FIG. 7), when the total length of matching character strings of the matching character string over 25 characters exceeds 90% (S2), the rate of the total length of matching character strings in the contents B (document B in FIG. 7) is judged (S3). Furthermore, when it matches 90% or more in the contents B, it is judged that there is a “total reuse relationship” between the contents A and B (S6). When the rate in the contents B is lower than 90%, it is judged that the reuse relationship between the contents A and B is “partially reused” (S7).

When the total length of matching character strings in the contents A is lower than 90% in S2, it is judged whether or not the total length of matching character strings exceeds 90% in the contents B (S4). When the rate of the total length of character strings exceeds 90%, it is judged that the reuse relationship between the contents A and the contents B is “partially reused” (S7). When the rate of the total length of character strings does not exceed 90% in S4, it is judged whether or not the matching character string is in the correct appearance order (matching judgment of appearance order of a character string) (S5). When the appearance order of a matching character string is correct (matching), it is judged that there is a “partial reuse relationship” between the contents A and B (S7). When the appearance order of a matching character string is not correct (not matching), it is judged that the reuse relationship between the contents A and B is “reference only” (S8).

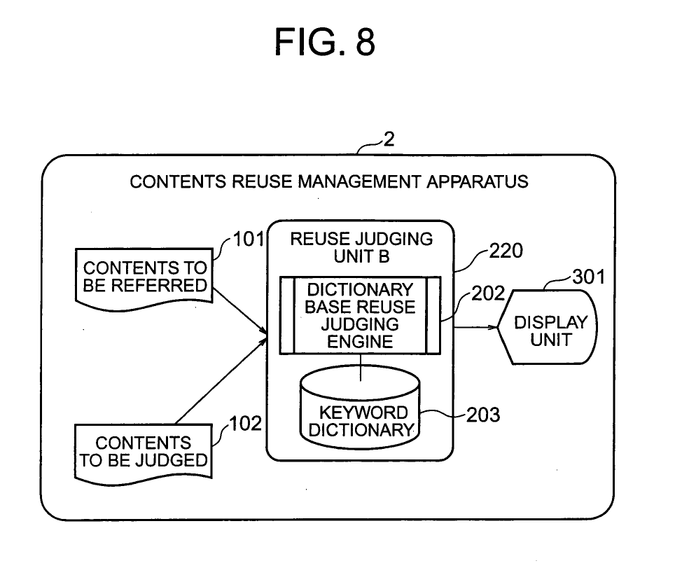

FIG. 8 shows the second embodiment of the present invention. In FIG. 8, the reference numeral also shown in FIG. 1 designates the same unit, and a contents reuse management apparatus 2 comprises a dictionary base reuse judging engine 202, a keyword dictionary 203, and reuse judging unit 220.

The contents reuse management apparatus 2 judges whether or not the contents 102 to be judged are generated by reusing the contents 101 to be referred based on a dictionary database including a keyword, a character string stored in the keyword dictionary 203.

The dictionary base reuse judging engine 202 judges whether or not the contents 102 to be judged have been generated by reusing the contents 101 to be referred using the keyword information stored in the keyword dictionary 203, a character string, and the dictionary information including the thesaurus, etc., and the result is stored by the CPU.

The keyword dictionary 203 stores the keyword information, the character string information, the dictionary information including the thesaurus, etc., and the description positions of the keyword and the character string, including the page number are described.

The reuse judging unit 220 judges whether or not the contents 102 to be judged have been generated by reusing the contents 101 to be referred using the keyword information and the character string information, and judges the reuse level including the judgments (1) to (4) like the reuse judging unit 210 shown in FIG. 1. When there is a plurality of dictionary information, it is important to judge the reuse relationship by checking the matching order.

Described below is the operation shown in FIG. 8. First, the keyword dictionary 203 stores the keyword information and the character string information in the contents 101 to be referred together with the storage position.

Then, the dictionary base reuse judging engine 202 reads the contents 102 to be judged, and detects the presence of the keyword, character string, etc. stored in the keyword dictionary 203. Based on the detection status including the keyword and the matching appearance order of a character string, etc., the judgments including the above-mentioned judgments (1) to (4) are made, the judgment result is output to the display unit 301, and is displayed for the user.

When a special keyword described only in the contents 101 to be referred is detected in the contents 101 to be referred, and the keyword is detected by the contents 102 to be judged, then it can be judged that the contents 102 to be judged have reused the contents 101 to be referred containing the special keyword.

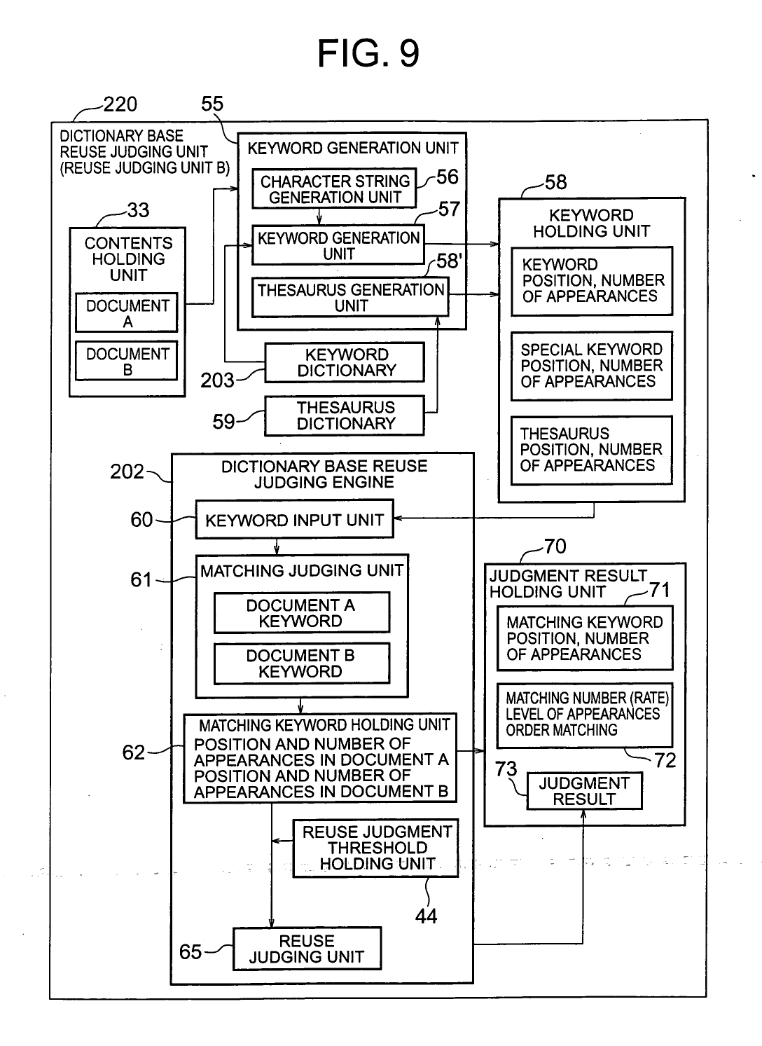

FIG. 9 shows the structure of the reuse judging unit according to the second embodiment of the present invention. In FIG. 9, the reuse judging unit B 220 judges the presence/absence of the reuse of the contents using a keyword. The apparatus comprises the contents holding unit 33 for holding contents, a keyword generation unit 55 for generating a keyword of contents by referring to the keyword dictionary 203, character string generation unit 56 for generating a character string of contents, keyword generation unit 57 for generating a keyword by referring to a keyword dictionary based on the generated character string, thesaurus generation unit 58′ for generating a thesaurus based on the generated keyword, and a thesaurus dictionary 59. A thesaurus is generated as necessary.

A keyword holding unit 58 holds a keyword of the generated contents, and a thesaurus for the keyword.

The reference numeral 202 denotes a dictionary base reuse judging engine. The reference numeral 60 denotes a keyword input unit. The matching judging unit 61 judges the matching keywords between the contents A and B. A matching keyword holding unit 62 holds the appearance position and the appearance order of the matching keyword between the contents A and B. The reuse judgment threshold holding unit 44 holds a threshold for judgment of the presence/absence of reuse and the use level. A reuse judging unit 65 judges the presence/absence of reuse of the contents A and B based on the number of matching keywords and the appearance order.

The judgment result holding unit 70 holds a matching keyword, the position of a keyword in the contents, and the appearance order. The judgment result holding unit 70 also holds the presence/absence of reuse, the judgment result including a reuse level, etc.

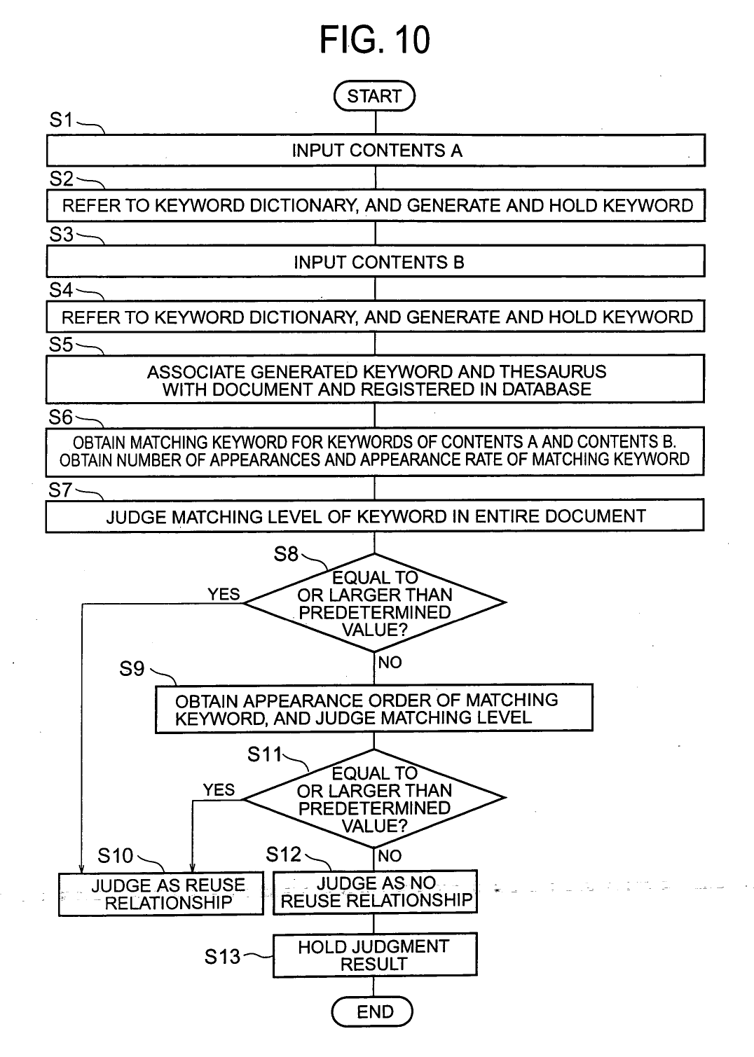

FIG. 10 is a flowchart of a reuse judgment according to the second embodiment of the present invention, and a flowchart according to the embodiment of the reuse judging unit B. The contents A are input (S1). A character string is generated, and a keyword is generated and held by referring to the keyword dictionary (S2). A thesaurus dictionary is referred to for the keyword to generate and hold a thesaurus (S3). The contents B are input to generate a character string also generate and hold a thesaurus (S4 and S5). A matching keyword is obtained between the contents A and B. Furthermore, the number of appearances, the appearance rate, and the matching level of the appearance order of the matching keyword are obtained (S6). The appearance rate of the matching keyword is compared with the threshold, and the matching level to the entire contents is judged (S7 and S8). When the rate of the matching keyword exceeds a predetermined value, it is judged that there is a “reuse relationship” between the contents A and B (S10). When it does not exceed the predetermined value, the rate of matching in the appearance order of a matching keyword is judged (S9 and S11). When the rate of the matching keyword in appearance order exceeds a predetermined value, it is judged as a “reuse relationship” (S10 and S11). When it does not exceed a predetermined value, it is judged as “no reuse relationship” (S11 and S12). The judgment result is held (S13).

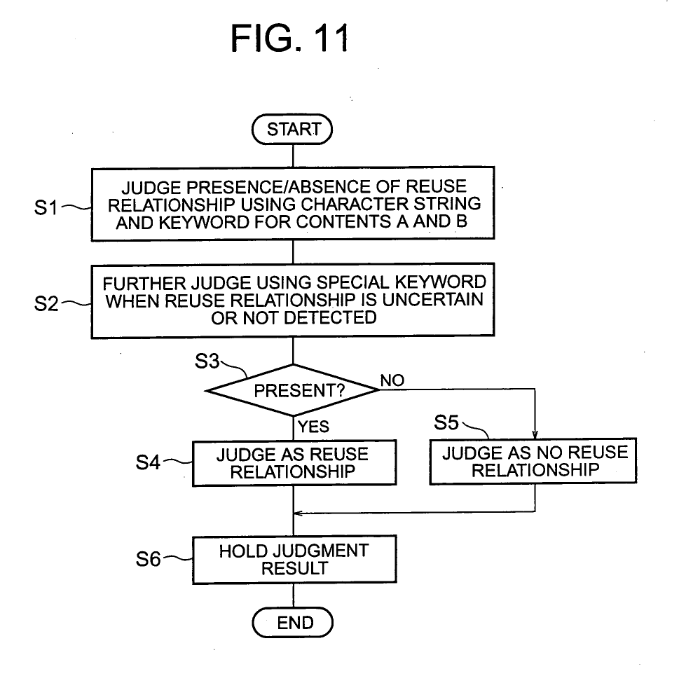

FIG. 11 is a flowchart of a reuse judgment using a special keyword according to the present invention, and a flowchart of judging that there is a “reuse relationship” between the contents A and B when there is a special keyword not used in other contents.

The reuse relationship is judged using a matching character string and a matching keyword between the contents A and B (S1). When the presence/absence of the reuse relationship is not certain in S1, or when it is judged that there is “no reuse relationship”, it is judged whether or not a special keyword is contained in the matching keyword (S2 and S3). When there is a special keyword in the matching keyword, it is judged as a “reuse relationship” (S4). When there is no special keyword, it is judged as “no reuse relationship” (S5). The judgment result is held (S6).

In the description above, the presence/absence of the reuse relationship is judged using a special keyword, but a space can be inserted to indicate specific information in the contents so that the reuse relationship can be judged by analyzing the appearance order of the space. For example, one space and the consecutive two spaces are inserted. One space represents 0, and two spaces represent 1. The insertion order of one space and two spaces is represented by 2-bit information having a specific meaning. The space between the contents A and B is analyzed. When the 2-bit information obtained by the spaces matches another, it can be judged as a “reuse relationship”. When the information does not match another piece of information, it can be judged as “no reuse relationship”.

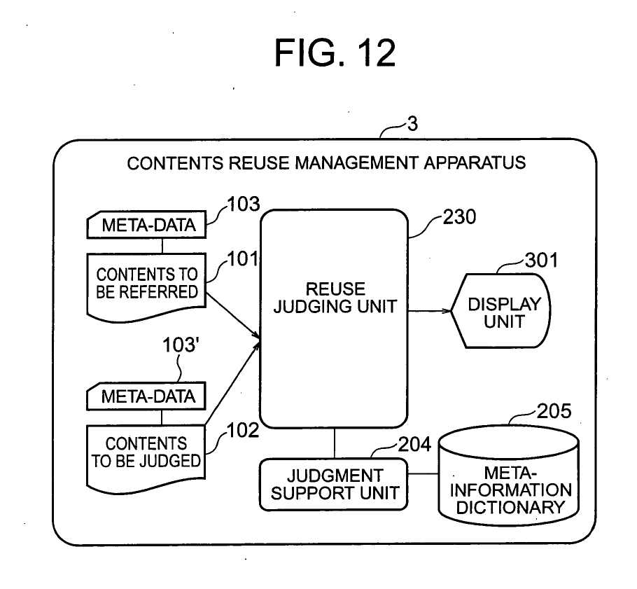

The third embodiment of the present invention is explained by referring to FIG. 12. In FIG. 12, the reference numerals also appearing in FIGS. 1 and 8 indicate the same units. The apparatus comprises a contents reuse management apparatus 3, the meta-data 103 and 103′, the judgment support unit 204, a meta-information dictionary 205 and reuse judging unit 230.

The contents reuse management apparatus 3 judges whether or not the contents 102 to be judged have been generated by reusing the contents 101 to be referred based on the meta-data including the generating person of the contents, the corrector of the contents, the generation date of the contents, etc., and the surface information or the keyword information.

The judgment support unit 204 provides the reuse judging unit 230 with the judgment support information for use in judging whether or not the contents 102 to be judged have been generated by reusing the contents 101 to be referred. For example, when the generating person of the contents 101 to be referred is A, and the generating person of the contents 102 to be judged is B, the relationship between the generating persons A and B, for example, the members of the same department or project, etc. is extracted from the meta-information dictionary 205 and provided.

The meta-information dictionary 205 stores in advance the relevant information about the meta-data of the contents 101 to be referred and the contents 102 to be judged, and includes the relevant information about each generating person, for example, the department or the project to which each generating person belongs, the friends of each generating person, etc. The reuse judging unit 230 judges whether or not the contents 102 to be judged have been generated by reusing the contents 101 to be referred, and is structured by the reuse judging unit 210 shown in FIG. 1 or the reuse judging unit 220 shown in FIG. 8. Therefore, when the reuse judging unit 230 is structured by the reuse judging unit 210 shown in FIG. 1, it comprises the surface information base reuse judging engine 201 and the surface information generation unit 206. When it is structured by the reuse judging unit 220 shown in FIG. 8, it comprises the dictionary base reuse judging engine 202 and the keyword dictionary 203.

The operation shown in FIG. 12 is explained by assuming the case in which the reuse judging unit 230 is structured by the reuse judging unit 220 shown in FIG. 8.

The dictionary information including a keyword, a character string, etc. described in advance in the contents 101 to be referred is stored in the keyword dictionary. The reuse judging unit 230 reads the generation date of the meta-data 103 and 103′ and judges it as “no reuse” when the generation date of the contents 102 to be judged precedes the generation date of the referred contents 101, and displays the judgment (4) on the display unit 301.

However, as described above by referring to FIG. 8, when the judgment (3) above holds based on the keyword and the character string, the reuse judging unit 230 retrieves the relationship between the generating person A of the contents 101 to be referred and the generating person B of the contents 102 to be judged using the meta-information dictionary 205, for the judgment support unit 204.

The judgment support unit 204 notifies the reuse judging unit 230 of the relationship information including that the contents generated by the generating person A that the generating persons A and B belong to the same project can be very easily recognized by the generating person B, that the generating persons A and B have not belonged to the same department or project in the company and the generating person B cannot possibly recognize the contents generated by the generating person A, etc.

Thus, when it is not certain whether or not the above-mentioned judgments (1) and (2) hold, the reuse judging unit 230, the judgment can be clearly made that the judgment (3) can hold when there is a strong possibility of recognition, and the judgment (4) can hold when there is no possibility of recognition. That is, a definite judgment (1), (2), (3), or (4) can be made.

Also when the reuse judging unit 230 is structured by the reuse judging unit 210 shown in FIG. 1, a definite judgment can be similarly made.

In the explanation above, meta-information is used to make a judgment on a reuse relationship when the reuse relationship is not certain. However, when the presence/absence of reuse is judged using meta-information and there is the possibility of reuse according to the meta-information, a judgment can be made on the reuse relationship by the matching result of a keyword and a character string. The method in this case is explained below.

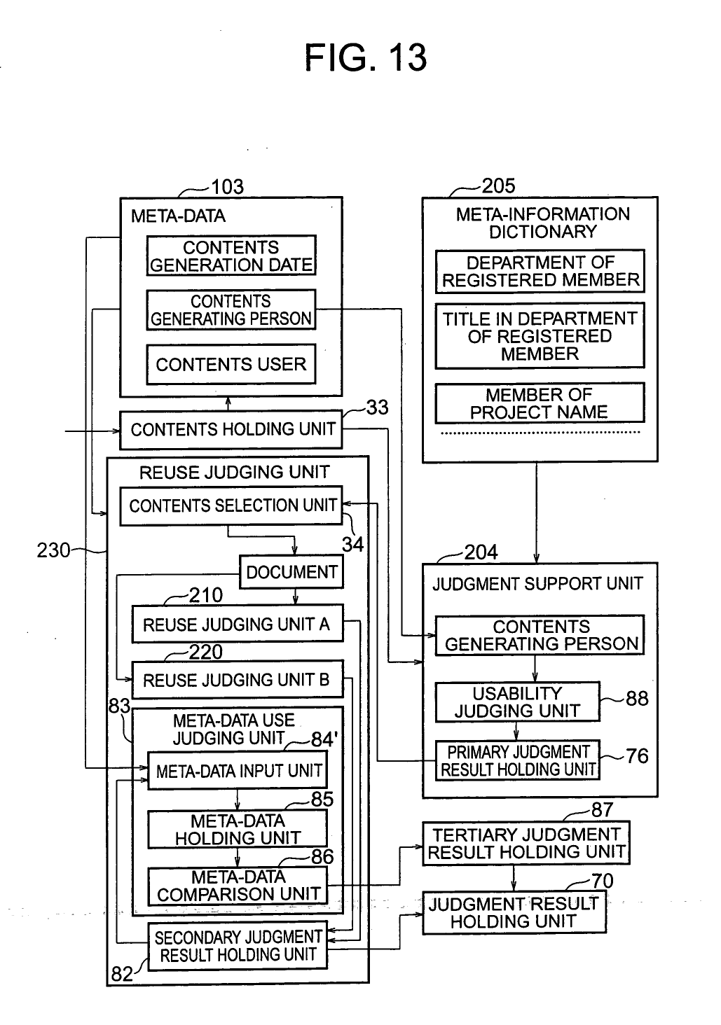

FIG. 13 shows the structure of the reuse judging unit according to the third embodiment of the present invention. The structure shown in FIG. 13 limits the contents for judging the presence/absence of the reuse relationship in advance using the meta-information, and the reuse of the contents is judged using the above-mentioned character string analysis and a keyword (the operation of limiting the contents are hereinafter referred to as narrowing). Furthermore, using the meta-data, it can be judged whether the contents having a reuse relationship is the contents reused by others or the contents obtained by reusing other contents.

In FIG. 13, the meta-data 103 indicates the contents generation date, the contents generating person (contents generator), the contents user, etc. The meta-information dictionary 205 holds the department of a member using a contents database, the title in the department of a registered member, the project name and the name of the members, the department to which the member belongs, etc. The judgment support unit 204 judges the reuse relationship using meta-information. A usability judging unit 88 uses the meta-information about the department of the contents generating person, etc. to judge the possibility of the reuse of contents. A primary judgment result holding unit 76 holds the result of the judgment on the presence/absence of reuse using meta-information.

The reference numeral 33 denotes a contents holding unit. The reuse judging unit 230 inputs contents for judgment on a reuse relationship. A contents selection unit 34 selects the contents judged as “possibly reused” as a result of the primary judgment. The reuse judging unit A 210 judges the contents reuse according to the surface character information. The reuse judging unit B 220 judges the reuse of contents using a keyword. A secondary judgment result holding unit 82 holds the judgment result of the presence/absence of reuse. A meta-data use judging unit 83 compares the generation date between the contents judged as “reused” by the reuse judging unit A and the reuse judging unit B, and judges the contents on the reused side and the contents of the reusing side. A meta-data input unit 84′ inputs the contents generation date. A reference numeral 85 denotes a meta-data holding unit. A meta-data comparison unit 86 judges the generation date. A tertiary judgment result holding unit 87 holds a comparison result of the meta-data comparison unit 86.

The operation of the structure shown in FIG. 13 is explained below using as an example the case in which the department of a contents generating person is used as meta-information for narrowing the contents. The contents holding unit 33 holds the contents for judgment of reuse. The judgment support unit 204 selects the generating person of the contents to be judged from the meta-data 103. The usability judging unit 88 obtains the department of the generating person by referring to the meta-information dictionary 205. As a result, it is judged whether or not the contents can be reused. When the departments to which the contents to be referred and the contents to be judged are different, it is assumed that the relationship of the reuse of contents does not occur, and no subsequent judgment is made on the reuse relationship. When a plurality of contents are set as contents to be referred, the contents which are possibly reused is narrowed by the judgment support unit 204, and the judgment result is held in the primary judgment result holding unit 76.

The contents selection unit 34 selects the contents judged as “possibly reused” from the result of the primary judgment made using the meta-information, and input. The reuse judging unit A 210 judges the reuse of contents by the surface information base reuse judging engine. The reuse judging unit B 220 judges the reuse of contents by a keyword. Based on the result of at least one of the reuse judging unit A and the reuse judging unit B, the secondary judgment result on the reuse of contents is obtained and held in the secondary judgment result holding unit 82. When it is judged that the results of both the reuse judging unit A and the reuse judging unit B indicate “reused”, and when it is judged that the judgment result is “reused” or one of them is “reused”, the secondary judgment result is judged as “reused”, or when one of them is judged as “reused”, it is judged that the secondary judgment result is “reused”. Thus, the judgment result is selected as necessary to use the respective judgment results. The secondary judgment result is held in the judgment result holding unit 70.

It is judged using meta-data whether the contents judged as “reused” in the secondary judgment result are reused contents or the reusing contents. The generation date of the contents judged as “reused” as a secondary judgment result is selected by the meta-data input unit 84′ from the meta-data 103, and input to the meta-data use judging unit 83. The meta-data comparison unit 86 compares the generation date of the contents (contents A and B) to be compared. It is judged that the contents having a preceding generation date are reused contents, and the contents having a succeeding generation date are reusing contents. The tertiary judgment result is held as associated with the contents in the tertiary judgment result holding unit 87.

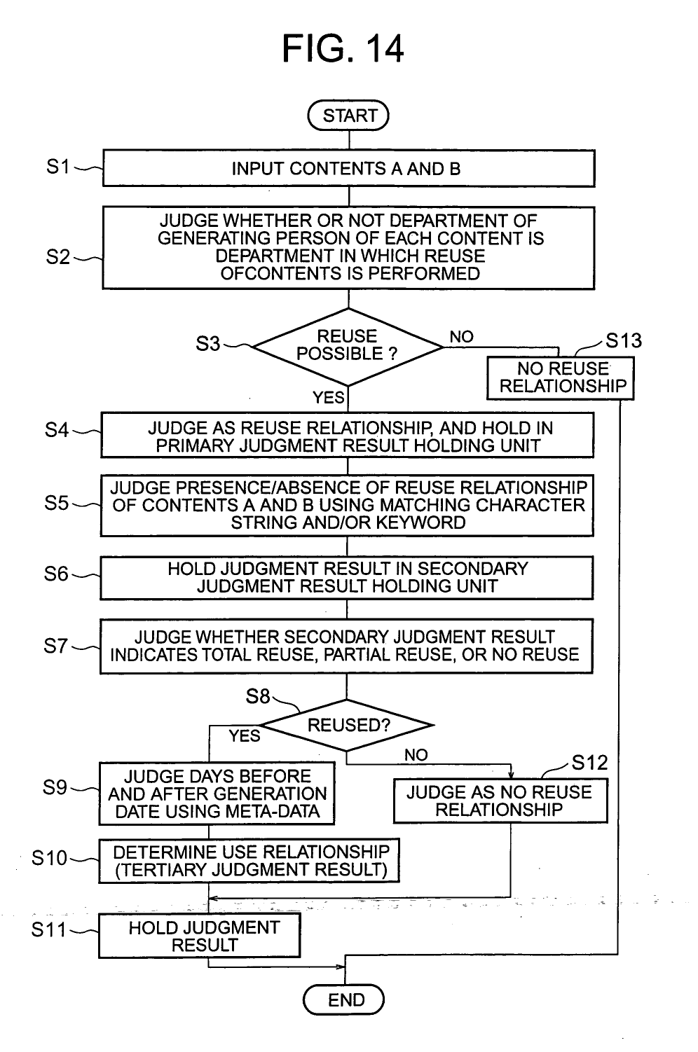

FIG. 14 is a flowchart of a reuse judgment according to the third embodiment of the present invention. The contents A and B are input (S1), and the department of the generating person of the contents is judged (S2 and S3). It is judged whether or not the department of the generating person has a “possible reuse relationship” (indicating that one is reused by another, or one reuses another) (S3). A department which is “impossibly reused” is judged as “impossibly reused” (S13), thereby terminating the process. When the department of the generating person has a “possible reuse relationship”, it is held as a “possible reuse relationship” in the primary judgment result holding unit (S4). The presence/absence of the reuse relationship of the contents A and B is judged by the comparison with a character string and a keyword (S5). The judgment result is held as a secondary judgment result (S6). Then, it is judged whether or not the secondary judgment result indicates a “reuse relationship” (S7 and S8), and when there is a “total reuse relationship” or a “partial reuse relationship” (including the “reference only” of the judgment (3)), the relationship of the contents A and B before and after the generation date is judged (S9). The dates before and after the generation date are judged, the contents having a preceding generation date are judged as reusing contents, and the contents having a succeeding generation date are judged reusing contents (tertiary judgment result) (S10). The contents judged as “not reused” as a secondary judgment result in S8 are judged as having “no reuse relationship” without a judgment using meta-data (S12), thereby terminating the process.

In the explanation above, the contents are narrowed with a judgment of the possibility of reuse by the department of the contents generating person, but the meta-information for narrowing the contents can be any other meta-information. Otherwise, the category of the contents (a thesis of scientific technology, a patent specification, etc.) can be assigned meta-information as associated with a file name so that the contents belonging to the same category can be “possibly reused” and the contents belonging to a different category can be “impossibly reused”.

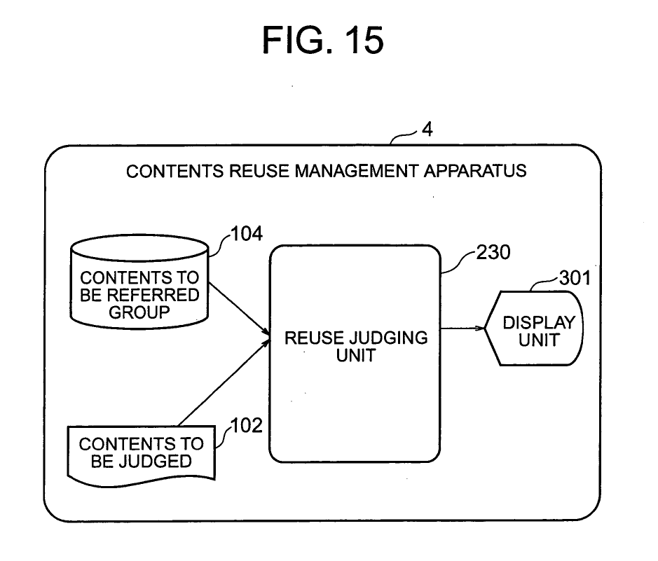

The fourth embodiment of the present invention is explained below by referring to FIG. 15. In FIG. 15, the reference numerals also appearing in other figures denote the same units, and a reference numeral 4 denotes a contents reuse management apparatus, and a reference numeral 104 denotes a contents to be referred group.

The contents reuse management apparatus 4 judges whether or not the contents 102 to be judged have been generated by reusing any of a plurality of contents to be referred stored in the contents to be referred group 104.

The contents to be referred groups 104 are a plurality of contents to be referred group on which it is judged whether or not the group has been reused to generate other contents, and can be structured by, for example, a server.

The operation shown in FIG. 15 is explained using the case in which the reuse judging unit 230 is structured by the reuse judging unit 220 shown in FIG. 8.

In advance, a keyword, a character string, etc. stored in the contents to be referred group 104 stored in a database are stored in a keyword dictionary together with the contents to be referred.

The reuse judging unit 230 reads the contents 102 to be judged, detects the presence of the keyword, the character string, etc. of the first contents to be referred stored in the keyword dictionary, makes the above-mentioned judgments (1) to (4), then detects the presence of a keyword, a character string, etc. of the second contents to be referred, and makes the above-mentioned judgment (1) to (4). Thus, the comparison with the keywords and the character strings of all contents to be referred stored in the keyword dictionary, and the judgment result can be sequentially displayed on the display unit 301.

Thus, the “reused” judgment on the contents of a plurality of contents to be referred groups can be efficiently made.

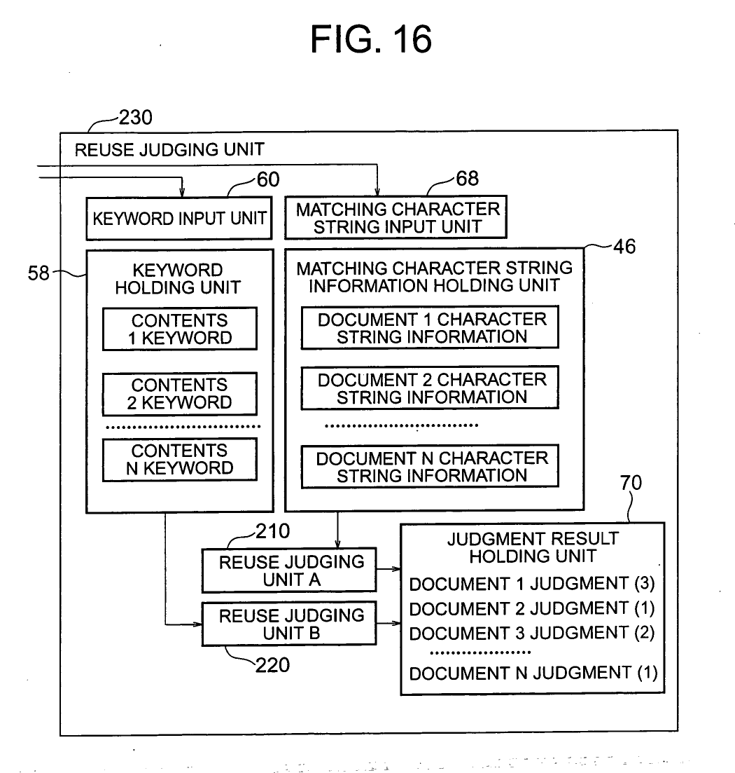

FIG. 16 shows the structure of the reuse judging unit according to the fourth embodiment of the present invention. The keyword holding unit 58 inputs a plurality of keywords using a keyword input unit 60, and holds them for each content. A matching character string input unit 68 inputs a matching character string between contents to be referred and contents to be judged. A matching character string is held for each content.

The reuse judging unit A judges the presence/absence of reuse of contents in the above-mentioned judging method based on a matching character string. The reuse judging unit B judges the presence/absence of reuse of contents. Each result is held in the judgment result holding unit 70 for each content. According to the present embodiment, the presence/absence of a reuse relationship of contents to be judged to a plurality of contents to be referred can be efficiently judged. Furthermore, all or a part of contents judged by the reuse judging unit A or the reuse judging unit B can be judged as necessary as to the presence/absence of reuse by making a judgment by the other reuse judging unit.

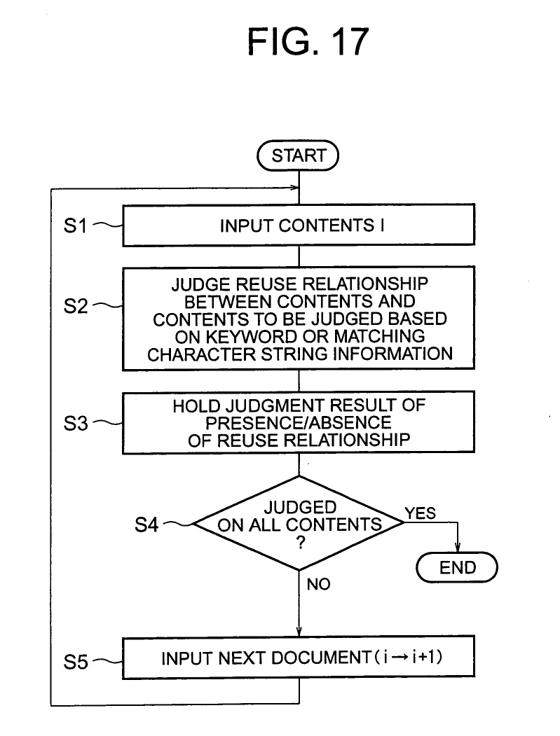

FIG. 17 is a flowchart of the reuse judging unit according to the fourth embodiment of the present invention. A keyword or a matching character string between contents to be referred (contents i) and contents to be judged is input (S1). When a matching character string between the contents to be judged and the contents to be referred is generated in advance, the generated matching character string can be used. A reuse relationship is judged depending on the matching level of the keyword or the matching character string information between the contents i and the contents to be judged. When no matching character string is generated for the contents, a matching character string is generated by the reuse judging unit A, and the presence/absence of reuse between the contents i and the contents to be judged is judged depending on the matching level of the matching character string. When no keyword is generated for the contents, a keyword is generated by the reuse judging unit B, and a reuse judgment is made between the contents i and the contents to be judged (S2). The judgment result about the presence/absence of reuse is held (S3). It is judged whether or not all contents have been judged. When all contents have not been judged, then the processes in and after SI are repeated on the next contents (S5). When all contents have been judged, the process terminates.

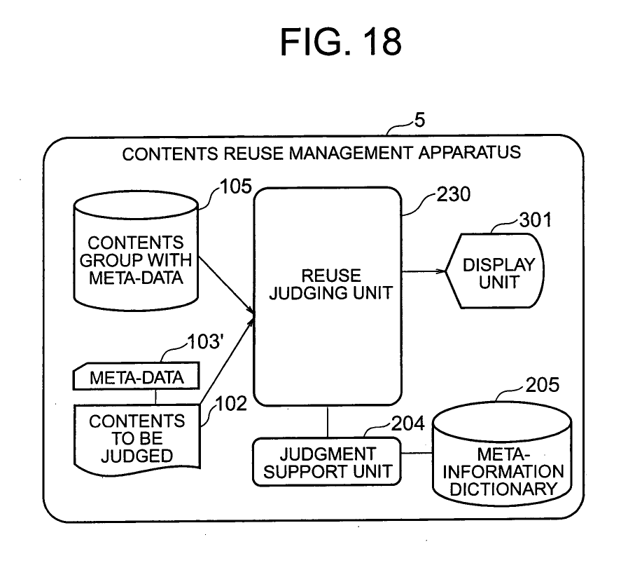

The fifth embodiment of the present invention is explained below by referring to FIG. 18. In FIG. 18, the reference numerals also appearing in other figures denote the same units. A reference numeral 5 denotes a contents reuse management apparatus. A reference numeral 105 denotes a reference contents group with meta-data.

The contents reuse management apparatus 5 judges whether or not the contents 102 to be judged have been generated by reusing any of the plurality of contents to be referred stored in the reference contents group 105 with meta-data.

The reference contents group 105 with meta-data are a plurality of contents to be referred for a judgment as to whether or not they are reused to generate other contents, stored in a database with the respective meta-data, and held in, for example, a server.

The operation shown in FIG. 18 is explained using the case in which the reuse judging unit 230 is structured by the reuse judging unit 220 shown in FIG. 8.

The dictionary information including a keyword and a character string relating to a plurality of contents to be referred stored in advance in the reference contents group 105 with meta-data is stored in a keyword dictionary.

The reuse judging unit 230 reads the meta-data of the first contents to be referred stored in the reference contents group with meta-data and the meta-data 103′ of the contents 102 to be judged, judges the contents as not reused when the generation date of the contents 102 to be judged precedes the generation date of the first contents to be referred, and displays the judgment (4) on the display unit 301.

However, as the operation explained by referring to FIG. 8, in the judgment based on a keyword and a character string, when the judgment (3) holds, the reuse judging unit 230 allows the judgment support unit 204 to retrieve the relationship between the generating person of the first contents to be referred and the generating person of the contents 102 to be judged from the meta-information dictionary 205.

As a result, as explained above by referring to FIG. 12, the reuse judging unit 230 judges whether or not the generating person of the contents to be judged can recognize the contents to be referred, and can clearly make the judgment (1), (2), or (4).

The above-mentioned process is sequentially performed on each referred-to content stored in the reference contents database with meta-data, and a judgment result can be displayed on the display unit 301.

Thus, a reuse judgment on a plurality of contents to be referred can be efficiently made using meta-data. In the explanation above, the reuse relationship is confirmed using meta-information after the judgment of reuse of contents using a character string or a keyword. However, the contents can be narrowed into those having a “possible reuse relationship” using meta-information in advance, and then a reuse judgment can be made using a keyword and a character string. In the following explanation, the method is used.

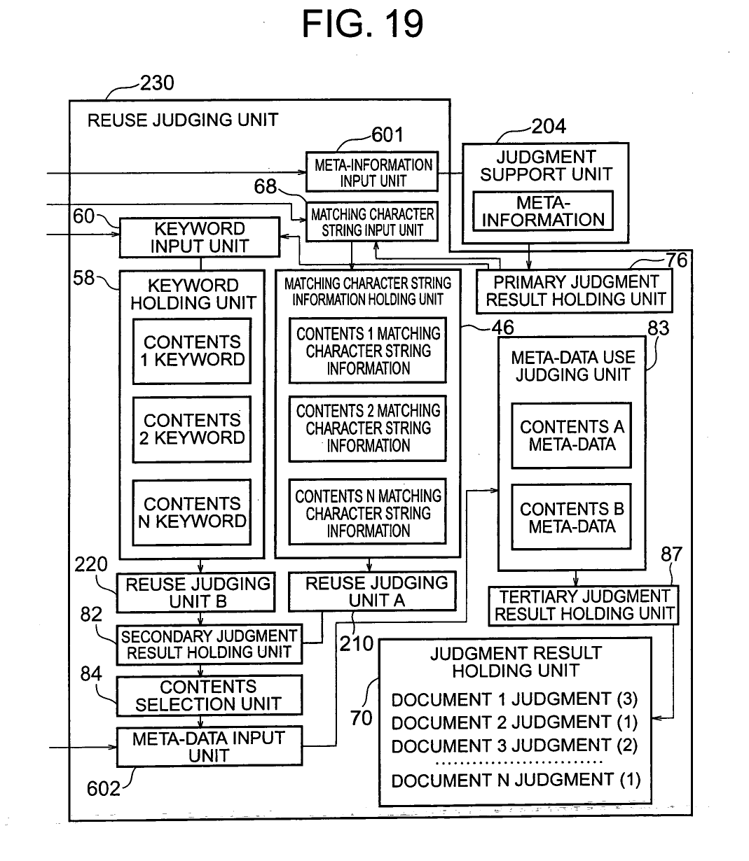

FIG. 19 shows the structure of the reuse judging unit according to the fifth embodiment of the present invention. In FIG. 19, the department of the contents generating person is judged before making a judgment using a keyword or a matching character string when a reuse relationship is judged on a plurality of contents, and only when the department of the generating person relates to a possible contents reuse relationship, the presence/absence of a contents reuse relationship is judged using a keyword and a matching character string.

In FIG. 19, a reference numeral 230 denotes reuse judging unit. A matching character string information holding unit 46 holds matching character string information about the contents to be referred matching the contents to be judged.

A meta-information input unit 601 inputs meta-information including the information about the department of the contents generating person. The judgment support unit 204 judges the presence/absence of the possibility of reuse of contents according to the meta-information. For example, the contents of the same department as the contents generating person have strong possibility of reuse. Therefore, the contents can be narrowed such that only the contents belonging to the same department as the generating person can be judged using a keyword or a matching character string. The primary judgment result holding unit 76 holds a judgment result about the possibility of the presence/absence of a reuse relationship obtained using meta-information.

The keyword input unit 60 inputs a keyword of contents when the keyword is generated for the contents. The matching character string input unit 68 inputs a matching character string, and inputs a matching character string when a matching character string has been generated for the contents to be judged. The keyword holding unit 58 holds a keyword of contents.

A reference numeral 220 denotes reuse judging unit B. A reference numeral 210 denotes reuse judging unit A. The secondary judgment result holding unit 82 holds judgment results of the reuse judging unit A and B. A contents selection unit 84 selects the contents judged as having a reuse relationship in the secondary judgment results.

A meta-data input unit 602 inputs a generation date of contents. The meta-data use judging unit 83 compares the generation dates of the contents judged as having a reuse relationship, and judges that the contents having a preceding generation date have been generated reused by other contents, and the contents having a succeeding generation date have been generated by reusing others. A reference numeral 87 denotes a tertiary judgment result holding unit. The judgment result holding unit 70 holds a reuse judgment result.

With the structure shown in FIG. 19, the presence/absence of reuse is judged based on the results of the reuse judging unit A an B. Otherwise, by assigning a higher priority to one judgment result, a result can be referred to when another result cannot be clearly judged, or many other methods can be selected.

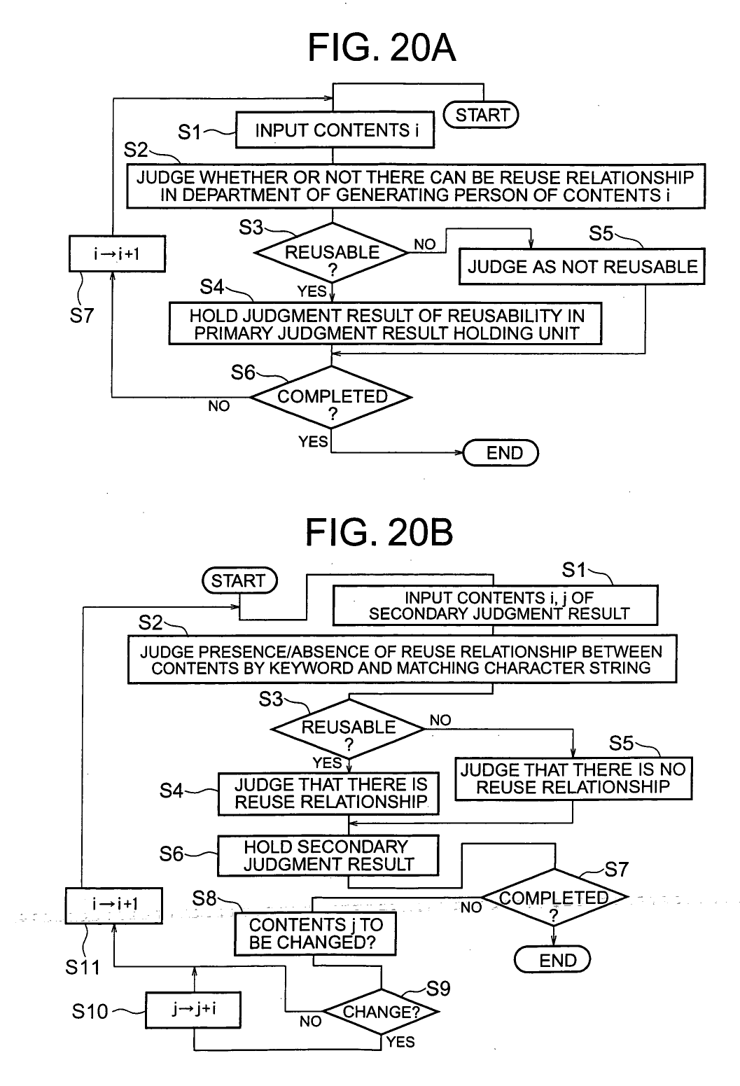

FIGS. 20A and 20B are flowcharts (1) and (2) according to the fifth embodiment of the present invention. FIG. 20A is a flowchart of the process of judging the presence/absence of the contents reuse relationship using meta-information. For example, when contents generating persons belong to the same departments or the departments having similar functions, the contents can be judged as possibly reused by each other. When contents generating persons belong to different departments, it is judged that there is no reuse relationship, thereby specifying the department and narrowing the contents having a reuse relationship. The contents i is input (S1). The department of the generating person of the contents i is judged (S2, S3). When a department has the possibility of reuse, it is judged as “possibly reused”, and the judgment result is held in the primary judgment result holding unit (S4). For example, a department having the possibility of reuse for contents to be judged is predetermined, and it is judged whether or not the generating person of the contents to be judged belongs to the department. All contents are judged for the possibility of reuse using the meta-information about all contents in S6. When the process is not completed, then the next contents are selected in S7, and the processes in and after S1 are repeated. When it is judged in the judgment in S6 that all contents have been processed, the process terminates. When the generating person of the contents i belongs to a department having no possibility of reuse in S3, then it is judged as “impossibly reused” (S5), and it is judged in S6 whether or not all departments of contents have been judged. When NO, the next contents are selected in S7, and the processes in and after S1 are repeated. When it is judged in S6 that all contents have been processed, then the process terminated.

FIG. 20B is a flowchart of judging the reuse of contents on a plurality of contents judged as “possibly reused” as a primary judgment result based on the keyword and the matching character string level.

Contents i and j which are judged as having a “possible reuse relationship” as a primary judgment result are input (SI). The presence/absence of reuse is judged using a keyword and a matching character string (S2 and S3). When a keyword and a matching character string between contents to be judged have been generated, the keyword and the matching character string are used for the contents. When no keyword or matching character string have been generated for contents, a keyword and a matching character string are generated, and the presence/absence of reuse is judged in the above-mentioned method. The judgment result of “reused” or “no reuse” is held in the secondary judgment result holding unit (S4, S5, and S6). It is determined whether or not all contents have been judged (S7). When NO, it is determined whether or not the contents j are changed. When YES, the next contents j are selected (S9 and S10), and the next contents i is selected in S11. When the contents j are not changed, the next i is selected without changing the contents j (S11). The processes in and after S1 are repeated, and when all necessary contents have been determined in S7, the process terminates.

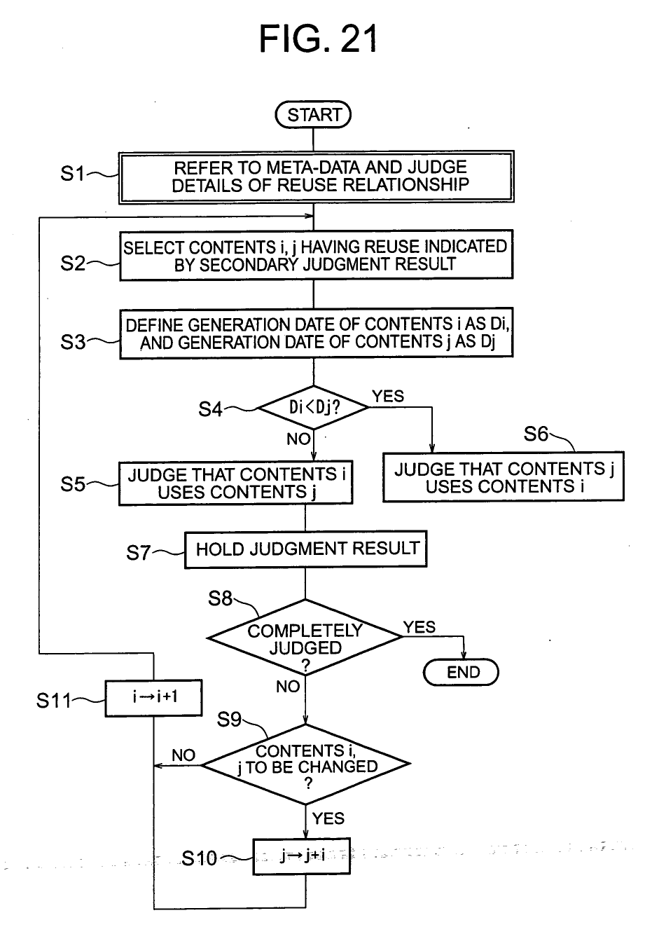

FIG. 21 is a flowchart (3) according to the fifth embodiment of the present invention. FIG. 21 shows the judgment of the reused contents and the reusing contents by referring to meta-data on the contents judged as having a “reuse relationship” based on a keyword or a matching character string analysis.

The detailed judging process of a reuse relationship is started by referring to meta-data (S1). The contents i and j having a secondary judgment result “reused” are selected (S2). The generation date of the contents i is defined as Di, and the generation date of the contents j is defined as Dj (S3). Di is collated with Dj for the order of the generation date (S4). When Di follows Dj, it is judged that the contents i are generated by reusing the contents j (S5). When Di precedes Dj, it is judged that the contents j are generated by reusing the contents i (S6). The detailed reuse relationship is held in the tertiary result area (S7). It is judged whether or not all necessary contents have been judged (S8). When not, it is determined whether or not the contents j are to be changed. When the contents j are to be changed, the next contents j are selected in S10. The next contents i are selected in S11, and the processed in and after S2 are repeated.

In the explanation above, the narrowed contents are judged by the department, but the contents can be narrowed using other meta-information (for example, the field of contents, etc.).

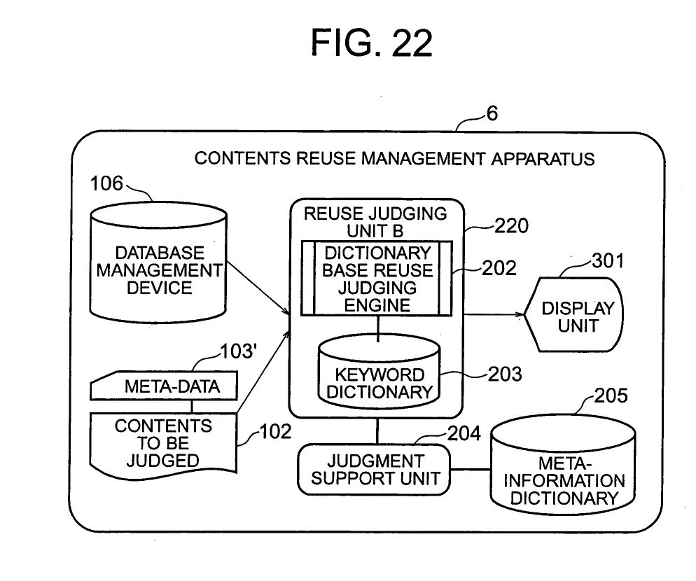

The sixth embodiment of the present invention is explained by referring to FIG. 22. In FIG. 22, the reference numeral also appearing in other figures indicates the same unit. A reference numeral 6 denotes a contents reuse management apparatus. A reference numeral 106 denotes a database management device. The database management device 106 manages the contents in a common database.

The contents reuse management apparatus 6 judges whether or not the contents 102 to be judged have been generated by reusing the contents stored in the database management device 106.

The database management device 106 stores the contents stored in the contents management system including groupware, etc. in each department of a company together with the meta-data including directory information, a generating person, a generation date, etc., and is structured by, for example, a server.

The keyword dictionary 203 stores common dictionary information including a keyword, a character string, etc. and a thesaurus, etc. specific to each department in advance.

The operation shown in FIG. 22 is similar to the above-mentioned operation and the detailed explanation is omitted here. By storing a reuse judgment result in the meta-information dictionary 205, the reuse history of contents in the department can be clarified, and the contents can be arranged from the viewpoint of reuse.

For example, when there are contents A, B, and C, it is judged that the contents B are generated by reusing the contents A, and it is stored in the meta-information dictionary 205, and when it is judged that the contents C have been generated by using the contents B, it is judged that the contents C have been generated by using the contents A. Therefore, the value of contents A is highly evaluated, and the reuse and importance of the contents A can be recognized.

Thus, according to the present invention, the relationship among the contents groups distributed in a company can be arranged from the viewpoint of reuse. Additionally, according to the present invention, important contents can be extracted from the viewpoint of reuse, and the contents can be used as a sample. The administrator can recommend using the sample among the members in the department, thereby allowing each member to easily generate contents with quality higher than a predetermined level.

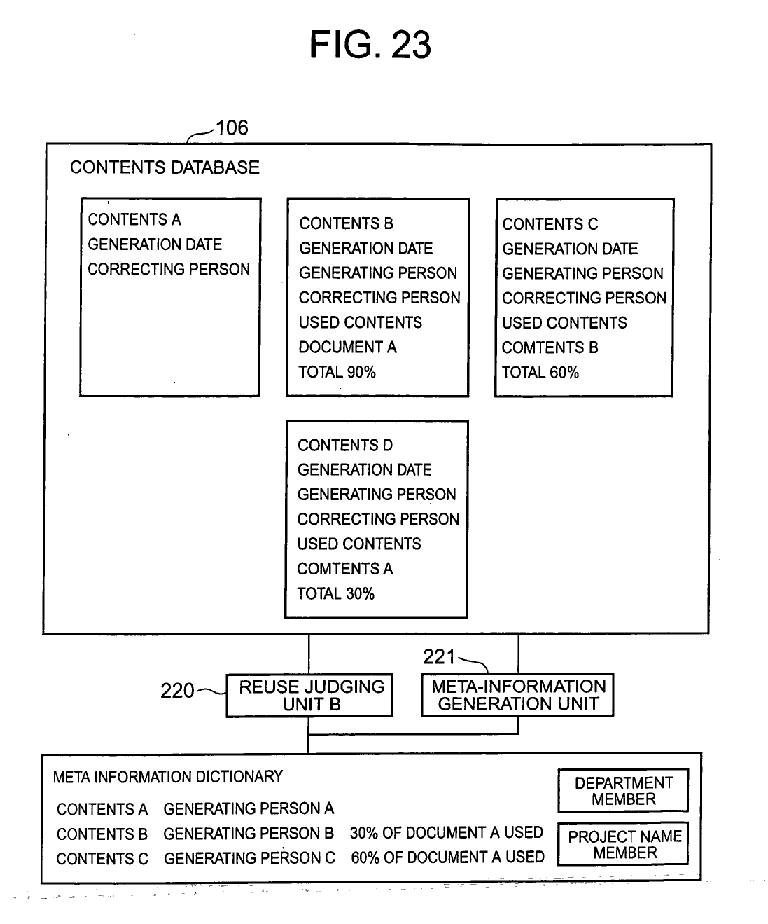

FIG. 23 is an explanatory view of the operation according to the sixth embodiment of the present invention. In FIG. 23, a reference numeral 106 denotes a database management device. There are contents A, B, C, and D. Using the reuse judging unit 220, it is judged, that the contents B are generated by 90% using the contents A. It is judged that the contents C are generated by 60% using the contents B. It is also judged that the contents D are generated by 30% using the contents A. The meta-information generation unit 221 retrieves a reuse relationship on the contents managed by the database management device 106, and holds the reuse relationship with the contents name in the meta-information dictionary 205. Since the reuse relationship refers to a close relationship in the department of the generating person, it is effective to hold it in the meta-information dictionary.

With the above-mentioned contents reuse management apparatus according to the present invention, contents generated by reusing other contents, or contents reused by other contents can be easily judged from among a number of contents.

Described below is the contents reuse management apparatus according to the present invention capable of easily reusing contents using the reuse result of contents as obtained above.

As described above, contents refer to, for example, a scenario, a template, a common document (having contents different from a scenario), and information processed by a computer including a text sample, graphic sample, etc. They can also include multimedia data including a moving picture, voice, etc. A scenario refers to a document formatted to a certain extent as, for example, a patent document. A template refers to, for example, an arrangement of only headers of document formats, and enables a document to be generated in a predetermined format based on the template. A document refers to common writing in any format. A text sample can be, for example, formatted salutation, a frequently cited specific sentence, etc. A text sample can be a frequently used portion.

A conventional contents management system registers generated contents in a directory or a library. When contents are reused, necessary contents can be fetched by retrieving a keyword and using a dictionary, and reuse can be realized by copying and pasting the original data.

According to the contents reuse support apparatus according to the present invention, reuse can be easily performed on various application contents, and using a number of reused contents, contents can be obtained at a low cost with constant quality. A user requesting reuse of contents can select high-quality contents by obtaining all or a part of evaluation of the contents to be copied, thereby easily generating high-quality contents.

The contents reuse support apparatus according to the present invention evaluates the contents in a database. Based on the given evaluation, a user selects contents and generates a draft of contents. Furthermore, by recording the process of generating the draft, the evaluation of the contents can be updated. Thus, by using the evaluated contents and managing the contents structured by the parts of the contents, the quality of the contents accumulated in the database can be enhanced.

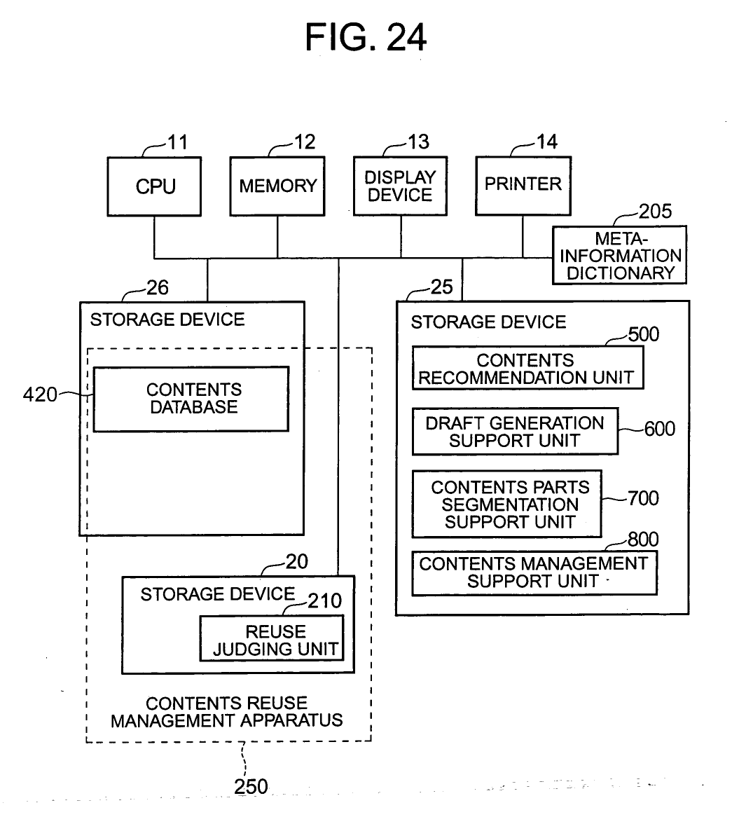

FIG. 24 shows the structure of the system of the contents reuse support apparatus according to the present invention. In FIG. 24, the system comprises the CPU 11, the memory 12, the display device 13, the printer 14, the storage device 20 for holding the reuse judging unit 210, etc., a storage device 25 for storing a program as various unit of the contents reuse support apparatus, a storage device 26 for storing a contents database used in the contents reuse support apparatus, a meta-information dictionary 205, and a contents reuse management apparatus 250 according to the present invention.

In the storage device 25, a contents recommendation unit 500 generates recommendation information for a user such that the user can determine the importance of contents having a high use frequency, a high use level, etc. A draft generation support unit 600 supports changing and editing contents, etc. according to the recommendation information. A contents parts segmentation support unit 700 supports the process of a user retrieving a common portion based on a plurality of contents. A contents management support unit 800 supports the process of amending the evaluation of contents based on the use frequency of the contents or treating contents into new contents pats based on the evaluation of the contents.

In the storage device 26, the contents database 420 holds contents.

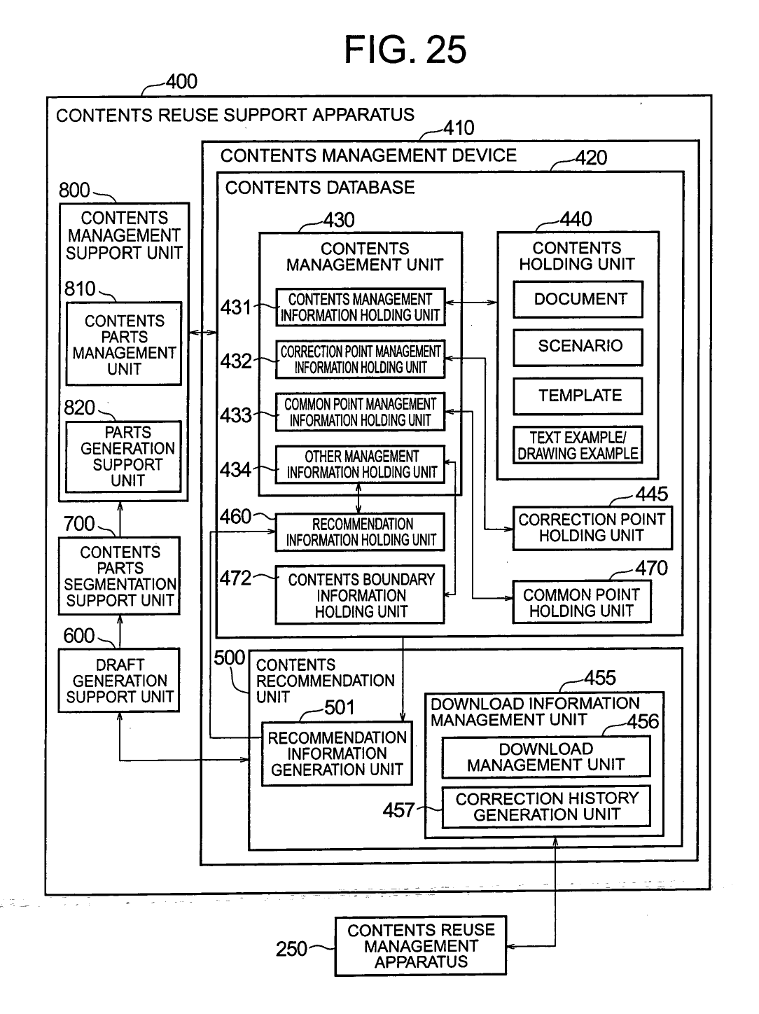

FIG. 25 shows the structure of the contents reuse support apparatus according to the present invention. In FIG. 25, a contents reuse support apparatus 400 is structured by a contents management device 410, the draft generation support unit 600, the contents parts segmentation support unit 700, and the contents management support unit 800. The contents management device 410 is structured by the contents database 420 and the contents recommendation unit 500.

The contents database 420 is structured by a contents management unit 430, a contents holding unit 440, a correction point holding unit 445, a common point holding unit 470, a recommendation information holding unit 460, and a 472. The contents management unit 430 comprises a contents management information holding unit 431 for holding contents management information including the frequency of download, a use rate, and a pointer to the correction point holding unit to each content, a correction point management information holding unit 432 for holding the correction point management information for management of the difference between contents, a common point management information holding unit to hold common point management information for management of common points between contents. Furthermore, it comprises a management information holding unit 434 for holding other management information including the management information for the recommendation information and the management information for the contents boundary information. The contents holding unit 440 holds various contents including a document, a scenario, a template, a text sample, and a drawing sample. The correction point holding unit 445 holds a correction point between contents. The common point holding unit 470 holds a common point among a plurality of contents. The recommendation information holding unit 460 holds recommendation information.

The contents recommendation unit 500 generates contents recommendation information. In the contents recommendation unit 500, a recommendation information generation unit 501 generates the number of use of contents, a use level, a retrieval result of the contents reuse management apparatus, reference contents display information (described later), derivative contents display information (described later). A download information management unit 455 manages downloading contents parts held in the contents holding unit 440, counts the frequency of downloading, and generates a correction history, etc. The management information is transmitted to a contents management unit and held therein. The data of the correction history is held by the correction point holding unit 445. The contents reuse management apparatus 250 is the same as the contents reuse support apparatus according to the present invention.

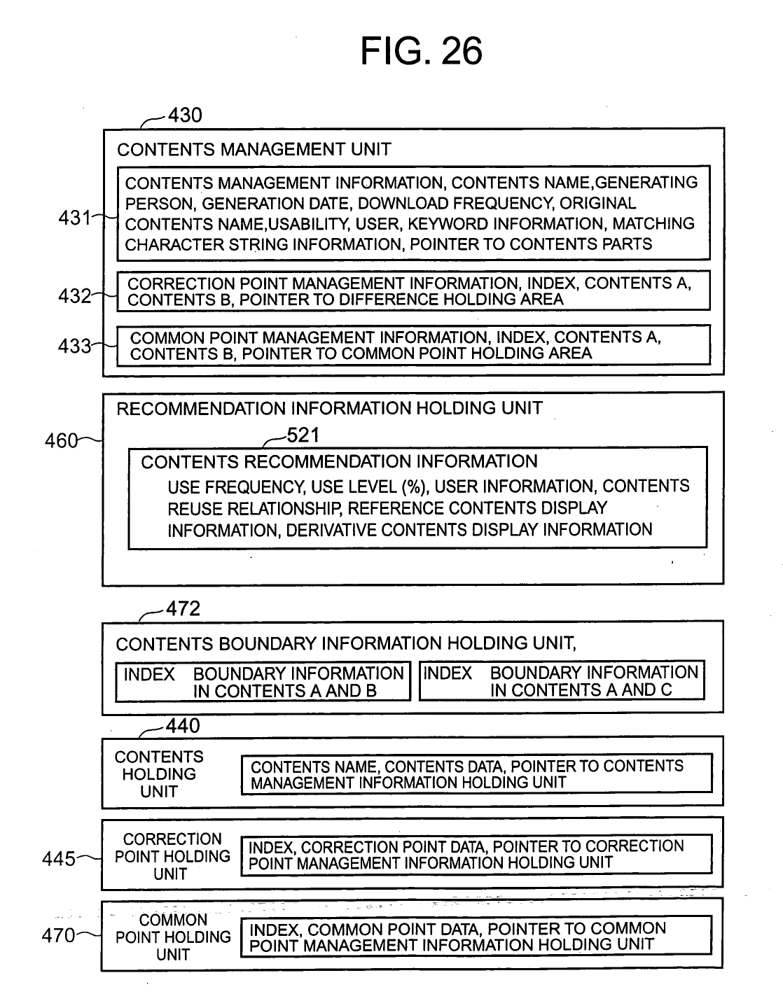

FIG. 26 illustrates the details of the structure of the contents database. The reference numeral 430 denotes a contents management unit. The contents management information holding unit 431 holds a contents name, a generating person, a generation date, the frequency of download, the original contents name when derivative contents are used, the use rate, a user, keyword information, matching character string information with original contents, and a pointer to the contents holding unit, etc.

The correction point management information holding unit 432 holds an index, contents A and contents B whose difference is obtained, a pointer to the correction point management information holding unit 432, etc. A common point management information holding unit 433 holds contents names (contents A and B) whose common point is obtained, and a pointer to a contents management unit 430, etc.

The contents holding unit 440 holds a contents name, contents data, and a pointer to the contents management information holding unit. The correction point holding unit 445 holds an index, correction point data, and a pointer to the correction point management information holding unit. The held correction point is assigned a contents parts name to generate contents parts. The common point holding unit 470 holds an index, common point data, and a pointer to the common point management information holding unit. A common point can be assigned a contents parts name to generate contents parts.

The recommendation information holding unit 460 holds contents recommendation information 521. The contents recommendation information holds the use frequency of contents (frequency of download), use level including total use, partial use, etc. (obtained by the contents reuse management apparatus 250 retrieving a contents database), user information, the retrieval result indicating the contents reuse relationship obtained by retrieving the contents reuse management apparatus according to the present invention, and the system of a contents reuse relationship, etc.

The contents boundary information holding unit 472 holds the information indicating the relationship before and after the use point when contents are used. For example, when a scenario is a-patent document the boundary information including the “unit to solving the problem”, “embodiments of the invention”, and “effect of the invention” indicating the boundary of the portions changed and not changed when only the embodiment of the original document is changed is held.

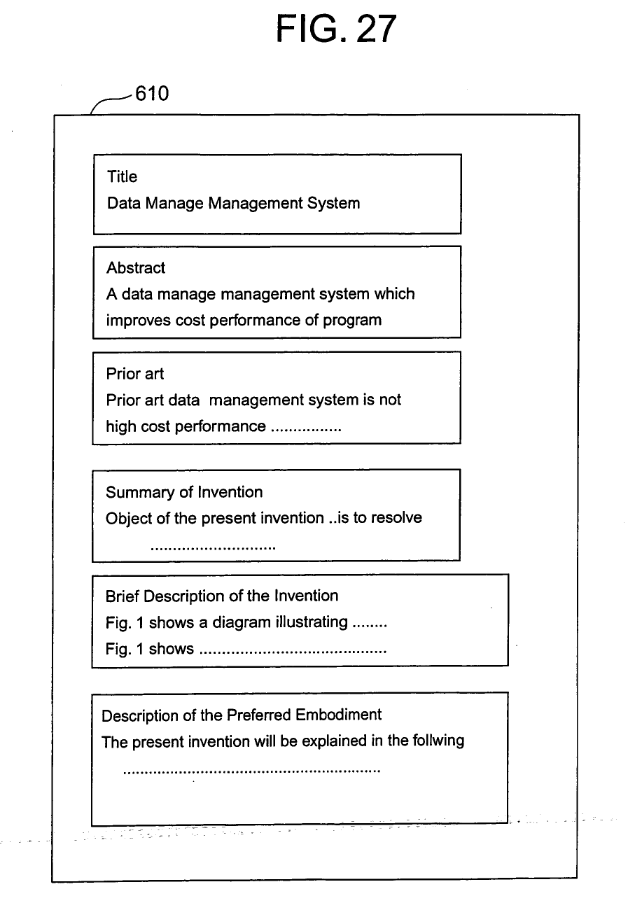

FIG. 27 shows an example of a scenario, and a patent application specification is described as an example. A scenario is a document having a fixed format. A reference numeral 610 denotes a scenario example.

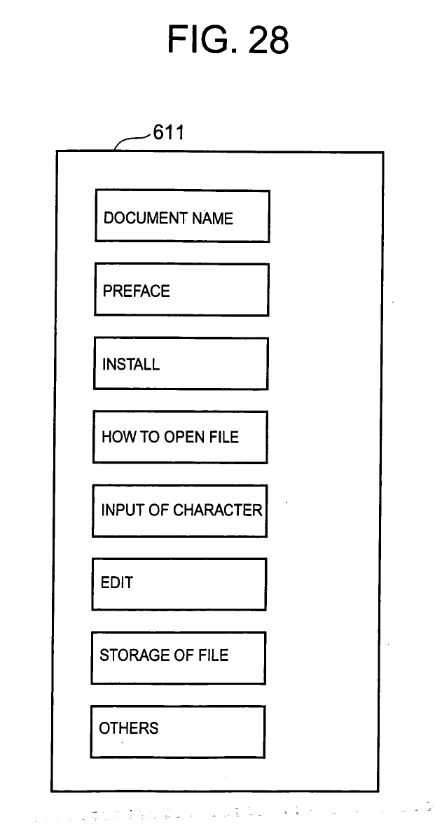

FIG. 28 shows an example of a template. A template 611 shows a document name and a header of, for example, a preface. A template only has a header assigned its own order, and a user enters a sentence, etc. according to the header, and generates contents of a document, etc. having a predetermined format.

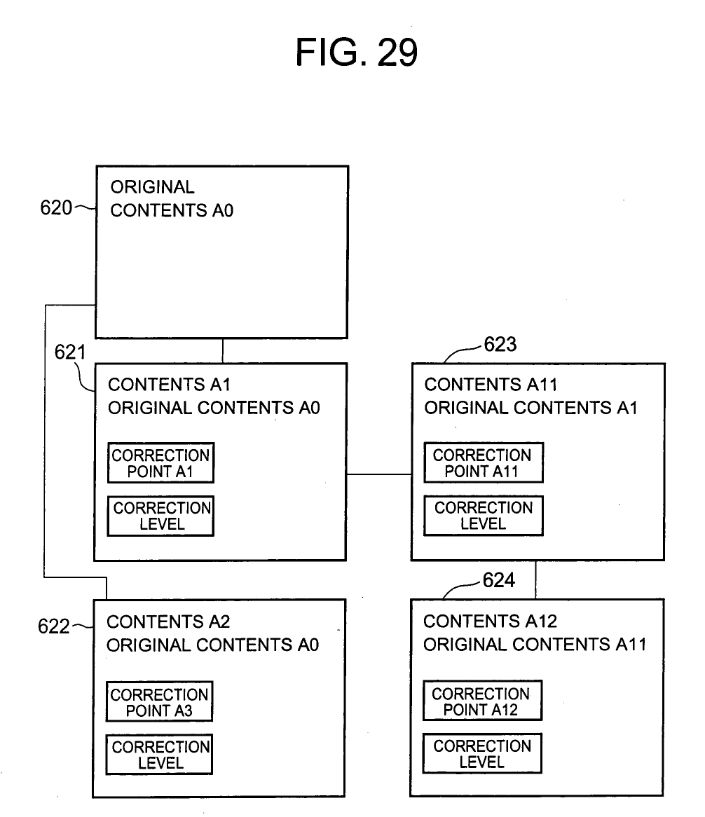

FIG. 29 is an explanatory view showing the original contents and the derivative. In FIG. 29, original contents 620 have a contents name A0. Contents 621 have a contents name A1, and are obtained by correcting the original contents A0. The contents A1 holds correction point information A1 for management of the difference from the original contents A0 as correction point information. Additionally, it holds correction level of a correction point as information. For example, the information about 60% correction of the original contents. Contents 622 have contents A2, and are obtained by correcting the original contents A0. Contents 623 have a contents name All, and are obtained by correcting the original contents A1. Contents 624 have a contents name A12, and are obtained by correcting the original contents All.

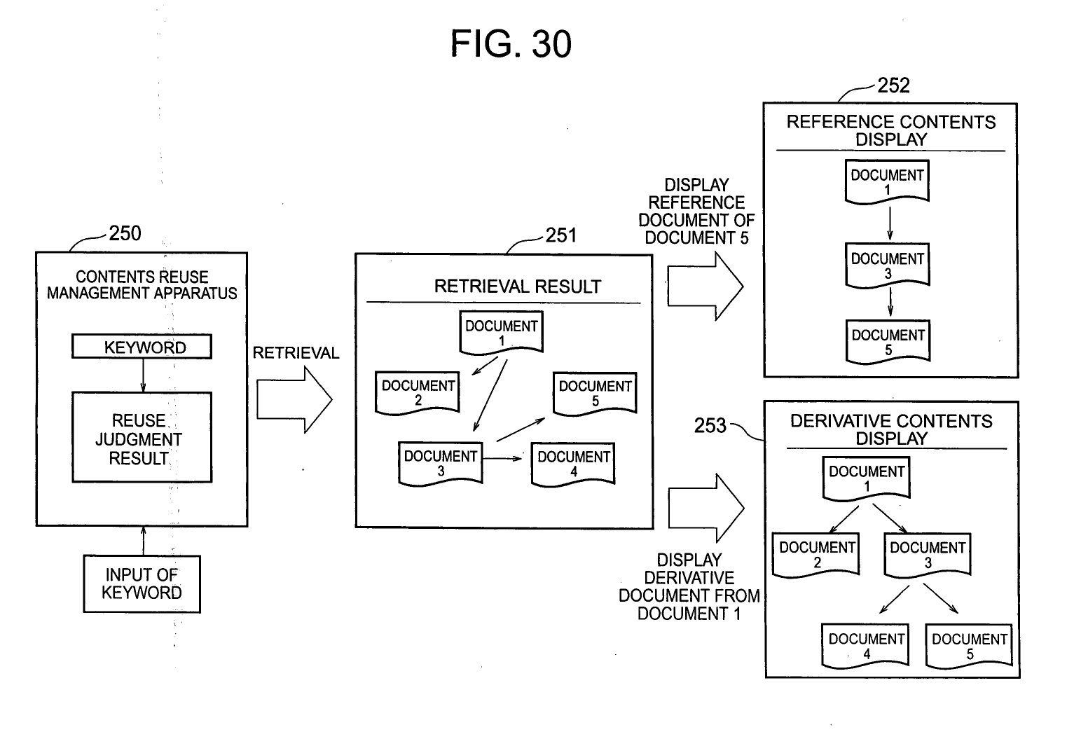

FIG. 30 is an explanatory view of the retrieval result of the contents reuse support apparatus, the reference contents display, and the derivative contents display when the co are documents. A reference numeral 250 denotes a contents reuse management apparatus. As described above, the reuse relationship of a document is retrieved by, for example, a keyword input, etc. A reference numeral 251 denotes a contents reuse relationship retrieval result. FIG. 30 shows the use relationship among the documents from a document 1 to a document 5. The documents 2 and 3 indicate the reuse of the document 1. The documents 5 and 4 indicate the reuse of the document 3.

A reference contents display 252 is displayed on a display device. The reference contents display specifies a target document based on the contents reuse relationship 251 of the retrieval result, and systematically shows the use relationship of the document A used by the document and the document used by the document A, etc. In the case of the example shown in FIG. 30, the document 5 is specified as a target document, the document 3 used by the document 5, and the document 1 used by the document 3 are obtained, and the relationship is displayed on the display device.

A derivative contents display derivative contents display 253 obtains the contents reuse relationship derived from the specified target document based on the contents reuse relationship retrieval result 251, and systematically displays it. In the example shown in FIG. 30, the document 1 is specified, the document 1 is used by the document 2 and 3, and the document 3 is used by the documents 4 and 5. The relationships are displayed on the display device as derivative contents display.

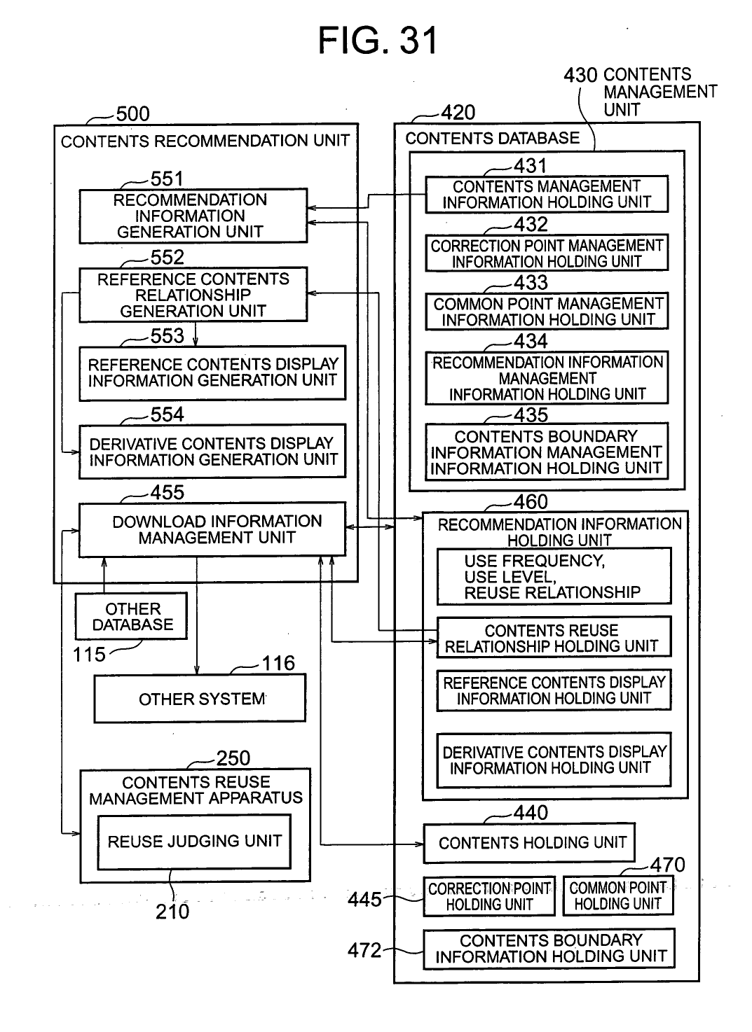

FIG. 31 is an explanatory view of the structure and the operation of the contents management apparatus according to the present invention. In FIG. 31, a reference numeral 420 denotes a contents database, and 430 denotes a contents management unit. The contents management unit 430 comprises the contents management information holding unit 431, the correction point management information holding unit 432, the common point management information holding unit 433, the management information holding unit 434, and a contents boundary information management information holding unit 435. The reference numeral 460 denotes the recommendation information holding unit.

The contents database further comprises the contents holding unit 440, the correction point holding unit 445, the common point holding unit 470, and the contents boundary information holding unit 472.

The contents recommendation unit 500 comprises the download information management unit 455, a recommendation information generation unit 551, and a reference contents display information generation unit 553. The reference numeral 250 denotes the contents reuse management apparatus according to the present invention. The reference numeral reuse judging unit 210 denotes reuse judging unit. A reference numeral 116 denotes another system using a database. The reference numeral 115 denotes another database.

The operation of the contents management apparatus shown in FIG. 31 is explained below. The contents reuse management apparatus 250 downloads the contents parts of the contents holding unit 440 through the download information management unit 455, and judges the reuse relationship. The judgment result is held by the contents management information holding unit.

In the recommendation unit 500, the recommendation information generation unit 551 generates recommendation information based on the contents management information (number of download times, reuse relationship, use rate, etc.) held in the contents management information holding unit 431, and holds the information in the recommendation information holding unit 460. The reference contents display information generation unit 553 generates reference contents display information based on the contents reuse relationship, and holds the information in the reference contents display information holding unit of the recommendation information holding unit 460. The derivative contents display information generation unit generates the derivative contents display information based on the contents reuse relationship held in the contents reuse relationship holding unit, and holds the information in the derivative contents display information holding unit.

Another system 116 can download and use the contents parts through the download information management unit 455. When contents are used and the contents are corrected, the download information management unit 455 generates a correction history, holds the data management information in the contents management information holding unit 431, and the corrected data is held in the correction point holding unit 445 using the difference as a correction point. The user of the contents reuse support apparatus of the present invention can access other databases 115 through the download information management unit 455 and can hold the data as the contents parts of the contents management database.

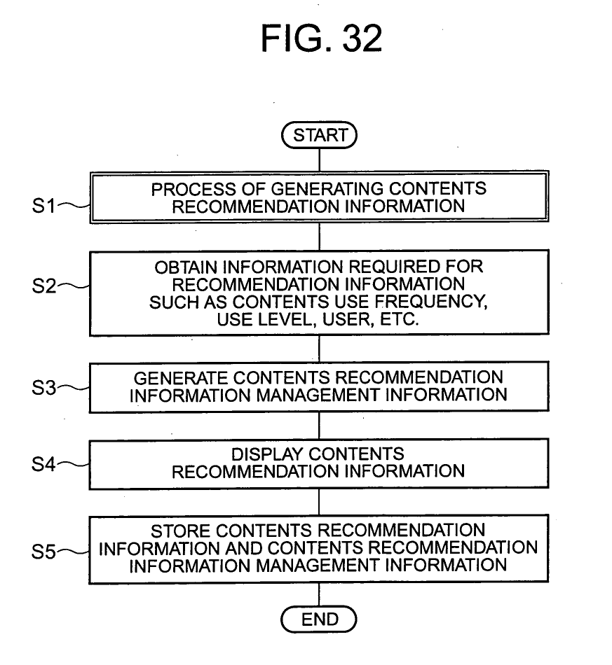

FIG. 32 is a flowchart of the contents recommendation information generation unit of the contents recommendation unit according to the present invention. The process of generating contents recommendation information is started (S1). The contents are obtained, the contents management information holding unit is retrieved, and the information required for contents recommendation including the reuse frequency of the contents parts, the reuse level, a user, etc. are obtained (S2). The contents recommendation information management information is generated (S3). The contents recommendation information is displayed (S4). The contents recommendation information and the contents recommendation information management information are held in the respective holding areas (S5).

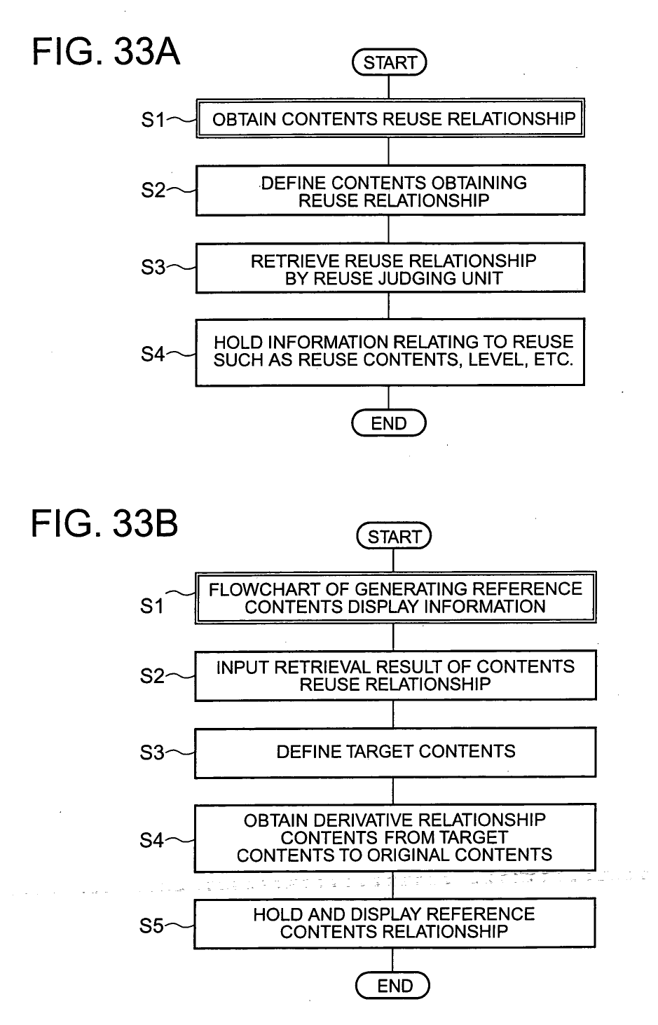

FIGS. 33A and 33B are a flowchart of the retrieval result of a contents reuse relationship and a flowchart of generating reference contents display information.

FIG. 33A is a flowchart of the retrieval result of the contents reuse relationship. The process of obtaining a reuse relationship is started (S1). The contents for obtaining a reuse relationship are defined (S2). The contents having a reuse relationship are retrieved using the reuse judging unit of the contents reuse management apparatus of the present invention (S3). The information including a contents name, a matching character string, a keyword, a reuse level, and a reuse relationship obtained as a retrieval result of the reuse contents are obtained, and held as reuse relationship information in the reuse relationship holding unit (S4).

Based on the reuse relationship held in the reuse relationship holding unit, the information including a matching character string, a keyword, and, a reuse level is held in the contents management unit.

FIG. 33B is a flowchart of generating reference contents display information. The process of generating reference contents display information is started (S1). The retrieval result of reuse of contents held in the contents reuse relationship holding unit is input (S2). Target contents are defined (S3). The derivative contents from the target contents back to the original contents are obtained (S4). The reference contents relationship is displayed and held (S5).

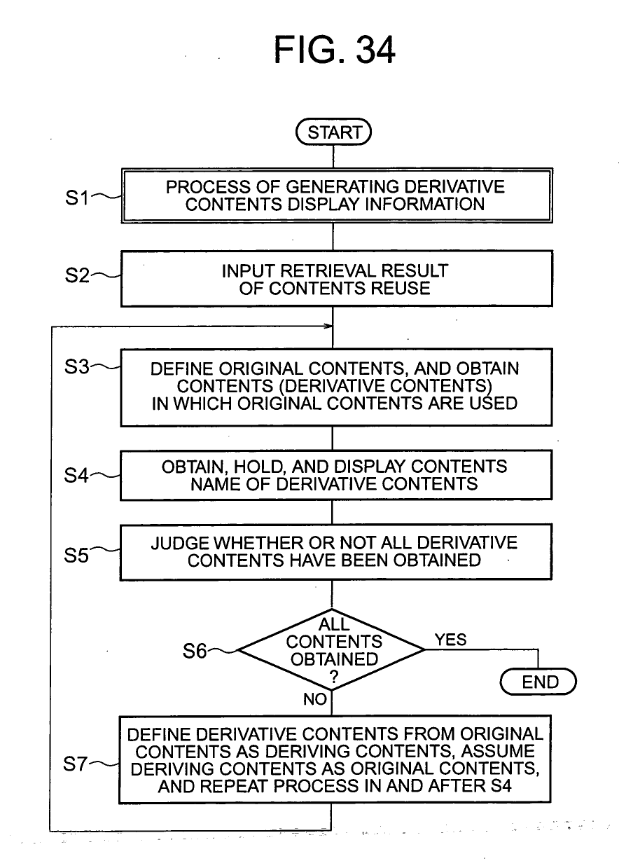

FIG. 34 is a flowchart of derivative contents display according to the present invention. The process of generating derivative contents display information is started (S1). A retrieval result of reuse of contents is input (S2). Original contents are defined, and the contents (derivative contents) using the original contents are obtained (S3). The contents management information including a contents name of the derivative contents is held (S4). It is judged whether or not all contents have been obtained (S5 and S6). When all contents have not been obtained, the processes in and after S4 are repeated using the derivative contents from the original contents as source contents (original contents) (S7). When all contents have been processed in S6, the process terminates.

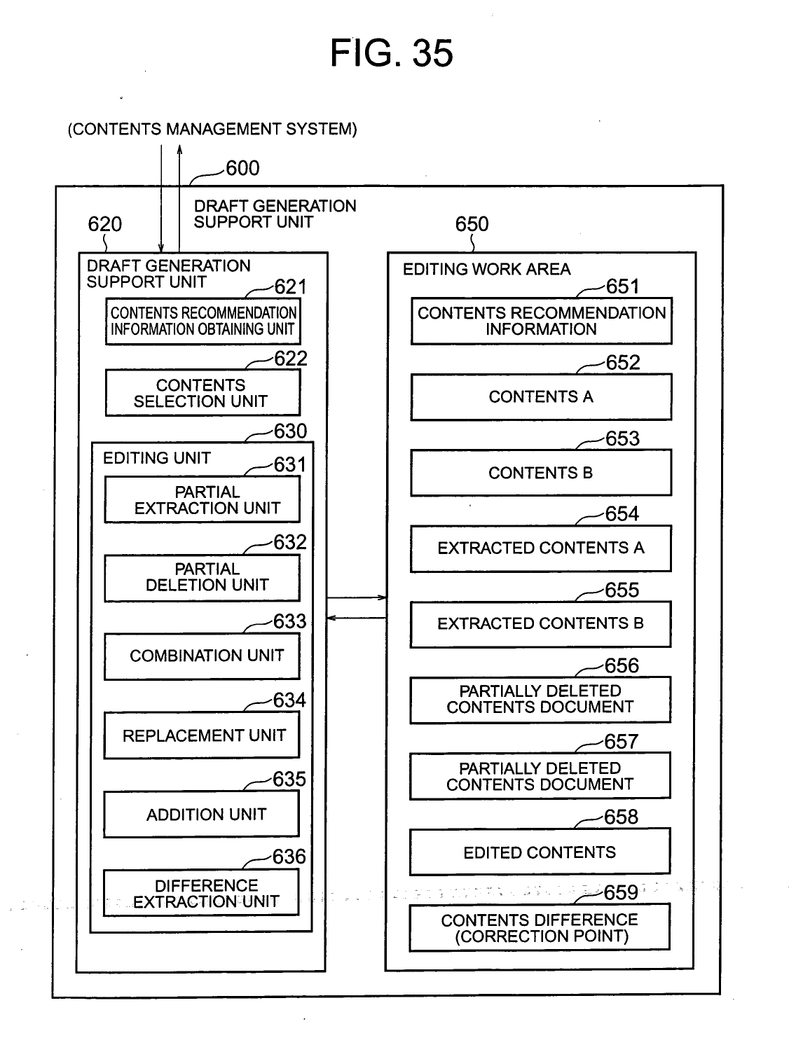

FIG. 35 shows the structure of the draft generation support unit according to the present invention. In FIG. 35, a reference numeral 600 denotes a draft generation support unit. The draft generation support unit 600 supports editing contents parts by using the memory as an editing work area 650 by draft generation support unit 620. When the draft generation support unit 620 is used to edit contents, a contents recommendation information obtaining unit 621 obtains recommendation information about the contents recommendation unit. Furthermore, contents selection unit 622 selects and inputs contents according to the recommendation information. A user edits the contents based on the contents displayed on the screen. Contents can be edited by partially extracting, partially deleting, combining a plurality of contents (combination or inclusion of extracted contents, etc.), partially replacing contents, adding contents, extracting a difference among a plurality of contents, etc. using the editing work area 650.

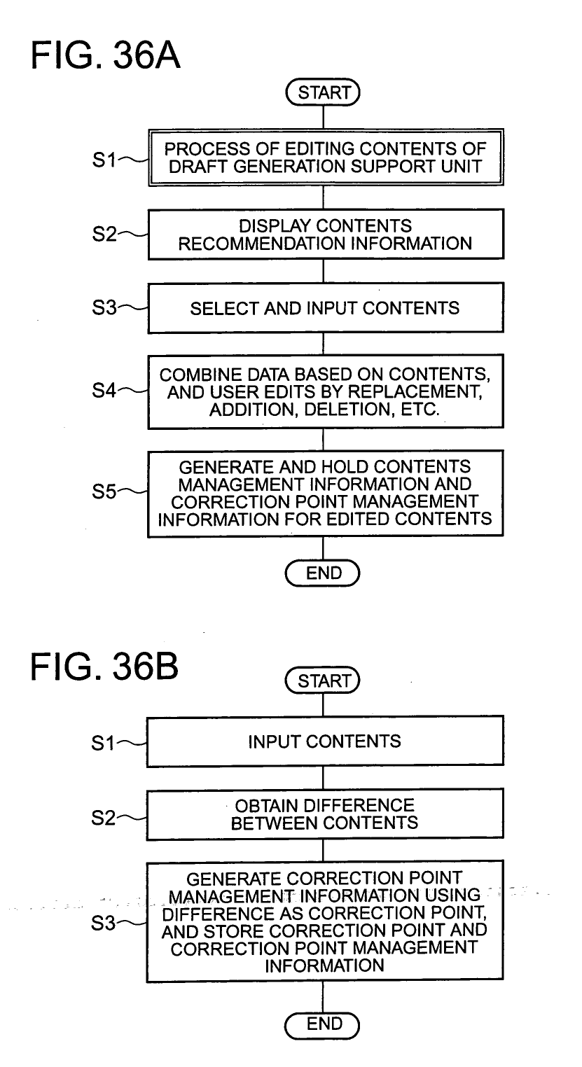

FIGS. 36A is a flowchart of the process of editing contents of the draft generation support unit. The contents editing process by the draft generation support unit is started (S1). The recommendation information obtaining unit obtains recommendation information, and the contents recommendation information is displayed (S2). Contents are selected and input (S3). Contents are combined, and a user edits contents by combination, replacement, addition, deletion, etc. (S4). The contents management information or correction point management information is generated for the edited contents, held in the contents holding unit or the correction point holding unit, and the contents management information or the correction point management information is held in the contents management information holding unit or the correction point management information holding unit (S5).

FIG. 36B is a flowchart of the difference extraction of the contents edited by the draft generation support unit of the present invention. The contents between which a difference is obtained is input (S1). A difference between contents is obtained (S2). When the difference is set as a contents part, contents management information is generated and held in the contents parts holding unit. When it is set as a correction point, correction point management information is generated and held in the correction point holding unit (S3). When the correction point held in the correction point holding unit is set as a contents part, the contents parts management information is generated for the correction point and is held in the contents holding unit, thereby obtaining a contents part.

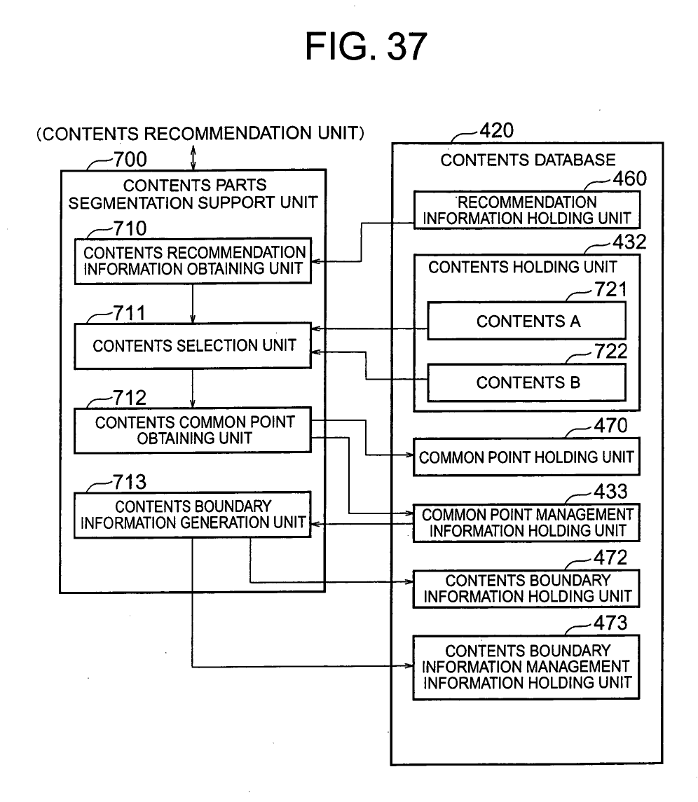

FIG. 37 shows the structure and the operation of the contents parts segmentation support unit according to the present invention. In FIG. 37, the reference numeral 700 denotes a contents parts segmentation support unit. The unit comprises contents recommendation information obtaining unit 710, contents selection unit 711, contents common point obtaining unit 712, and contents boundary information generation unit 713. The reference numeral 420 denotes a contents database.

The method of obtaining a common point (that is, a common portion) of a plurality of contents by the contents reuse support apparatus according to the present invention is explained below by referring to FIG. 37. The contents recommendation information obtaining unit 710 obtains contents recommendation information from the recommendation information holding unit 460, and displays it. The user selects contents through the contents selection unit 711 according to the contents recommendation information. For example, in the case shown in FIG. 37, the contents A and B are selected. The contents common point obtaining unit 712 obtains the common point between the contents A and B. The common point is provided with an index and a pointer to the common point management information holding unit, and is held by the common point holding unit. Then, the common point management information is provided with the index of the common point, the contents name for a trigger of segmentation of the common point, and a pointer to the common point holding unit, and is then held. The common point held in the common point holding unit 470 is set as contents parts by being provided with contents parts management information (contents parts, a pointer to the contents holding unit, etc.), and can be held in the contents holding unit. The generated contents parts are provided with a file name and a pointer to the contents management information holding unit, thereby linking to the contents management information holding unit.

Described below is the operation of the contents boundary information generation unit 713 according to the present invention. The contents boundary information generation unit 713 obtains boundary information boundary information which is area information about the area before and after the common point in the respective contents based on the common point of a plurality of contents. That is, it is judged what area before and after the common point in the respective contents is. For example, when the contents A and B are the templates as shown in FIG. 28, and only an editing area is common, the boundary information about the common point can be “input and edit a character” and “edit and store a file”. The boundary information is stored in the contents boundary information holding unit 472. By checking the distribution of the boundary information about a number of contents generated by a template, it can be easily judged how the template is used. By analyzing the contents boundary information, it can be judged what template is to be generated when new template parts are generated, and the contents boundary information is effective reference information in generating new contents parts.

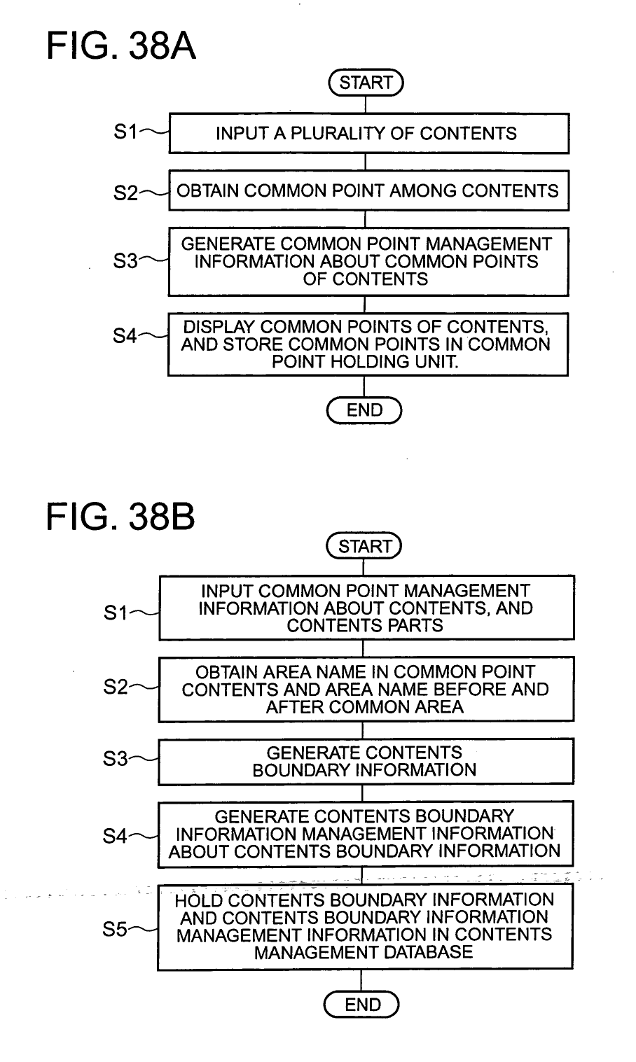

FIG. 38A is a flowchart of the common point obtaining unit of the contents parts segmentation support unit according to the present invention. A plurality of contents are input (S1). A common point of each content is obtained (S2). The common point of the contents is displayed (S3). By providing the common point of the contents with the common point management information (index of a common point, each contents name with the common point extracted, pointer to the common point holding area, etc.) and by providing an index, a pointer to the common point management information, etc. for the common point, a link can be established for coupling each other, and held in the common point management information holding unit and the common point holding unit (S4).

FIG. 38B is a flowchart of the contents boundary information generation unit according to the present invention. The information about the common portion of contents is input (S1). The area name in the contents of the common portion (for example, the header of edition of the template, etc. shown in FIG. 28) and the area name before and after (for example, the header of character input of the template, storage of a file, etc. as shown in FIG. 28) are obtained (S2). The contents boundary information is generated (for example, “input and edit a character” indicating that the boundary is located between the character input area and the editing area and “edit and store a file” indicating that the boundary is located between the editing area and the file storage area, etc.) (S3). The contents boundary information management information is generated by assigning the contents boundary information management information (index, contents name, pointer to a contents boundary information holding unit, etc.) to the obtained contents boundary information. An index and a pointer to the contents boundary information management information holding unit are generated for the contents boundary information, and a link is established using a pointer (S4). The contents boundary information management information and the contents boundary information are respectively held in the contents boundary information management information holding unit and the boundary information holding unit of the contents management database (S5). As described above, the contents boundary information is obtained based on the area of the common point of contents, but contents boundary information can also be obtained based on the area of a correction point of contents.

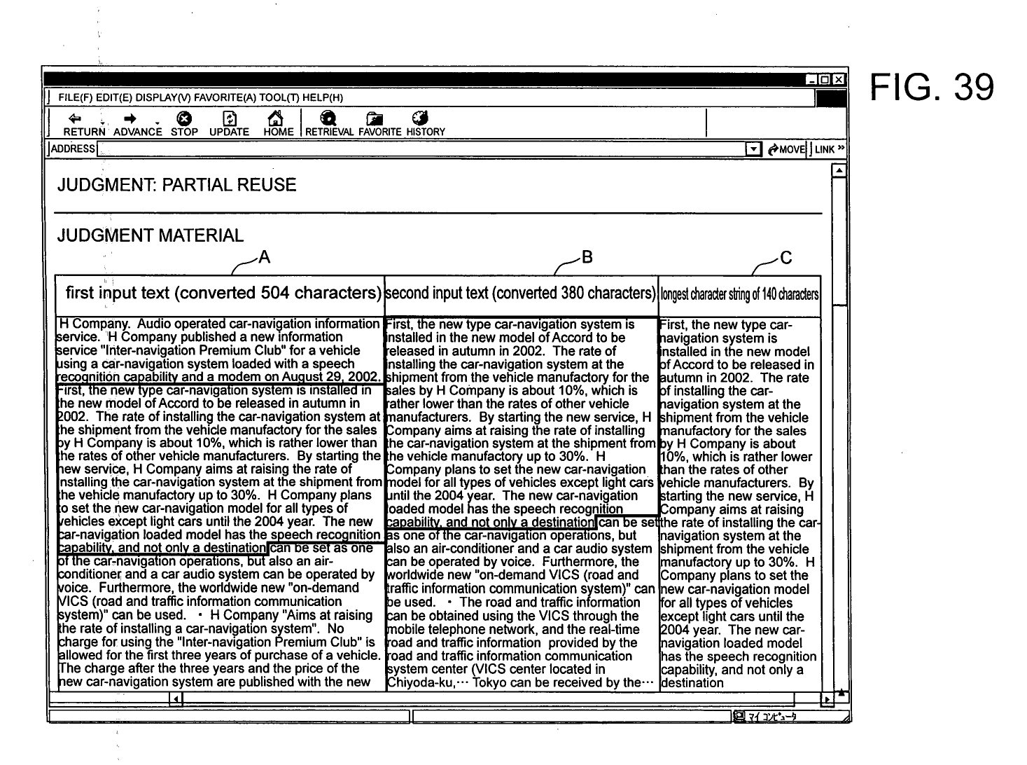

FIG. 39 shows an example of the common point (common portion) extracted from contents according to the present invention. In FIG. 39, A indicates the contents A, B indicates a contents B, and C indicates a common point between the contents A and B.

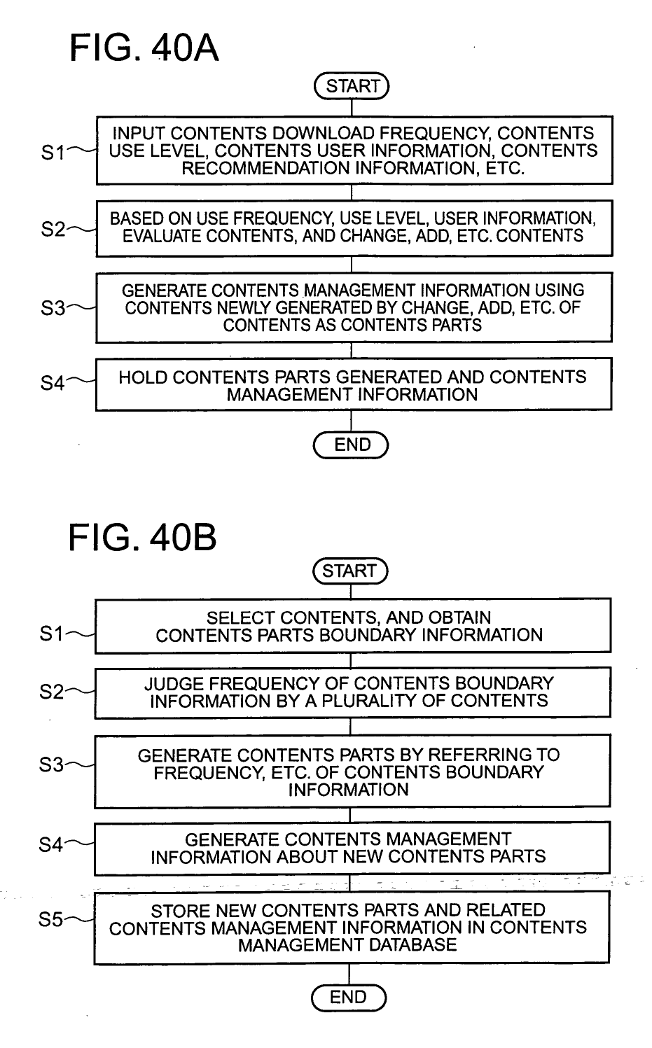

FIG. 40A is a flowchart of the contents parts management unit of the contents management support unit according to the present invention. A user (contents management staff) inputs a number of download times of contents, a contents use rate, contents user information, and contents recommendation information (S1). The importance of the contents is evaluated based on the number of download times, the contents use rate, and contents user information, and new contents parts are generated (S2). The contents parts management information is generated for the newly generated contents parts (S3). The contents parts management information is held in the contents parts management information holding unit, and the contents parts are held in the contents parts holding unit (S4). A link is established so that the contents management information and the contents parts can be coupled with each other.

A high number of download times indicates important contents, and when the used portions are distributed, it unit the used portions are of importance. In this case, more easily used parts can be generated by setting the portions as original contents parts. When contents are used by a specific user group, more easily used parts can be generated by treating them as contents parts appropriate for the group. For example, it can be realized by generating a new template, etc. by regenerating a header according to the contents boundary information. The contents boundary information can be reference information for use in generating parts by the contents parts management unit.

FIG. 40B is a flowchart of generating contents parts according to the contents boundary information of the present invention. A parts generation support unit 820 generates and corrects contents parts according to the contents boundary information. However, it only shows an example of generating contents using the contents boundary information, and there are various aspects of a contents generating method using the contents boundary information. For example, when a template is changed in generating template parts, the contents boundary information about contents using a target template is obtained (S1). The frequency of appearances, etc. is obtained by the statistics, etc. of the contents boundary information (S2). By referring to the frequency, etc. of the contents boundary information, new contents parts are generated (S3). For example, contents parts of a new template, etc. are generated by, for example, reserving a header of a frequently changed area and deleting an unused portion, etc. Contents management information is generated for new contents parts (S4). The contents parts are held in the contents holding unit of the contents database, and the contents management information is stored in the contents management information holding unit (S5).

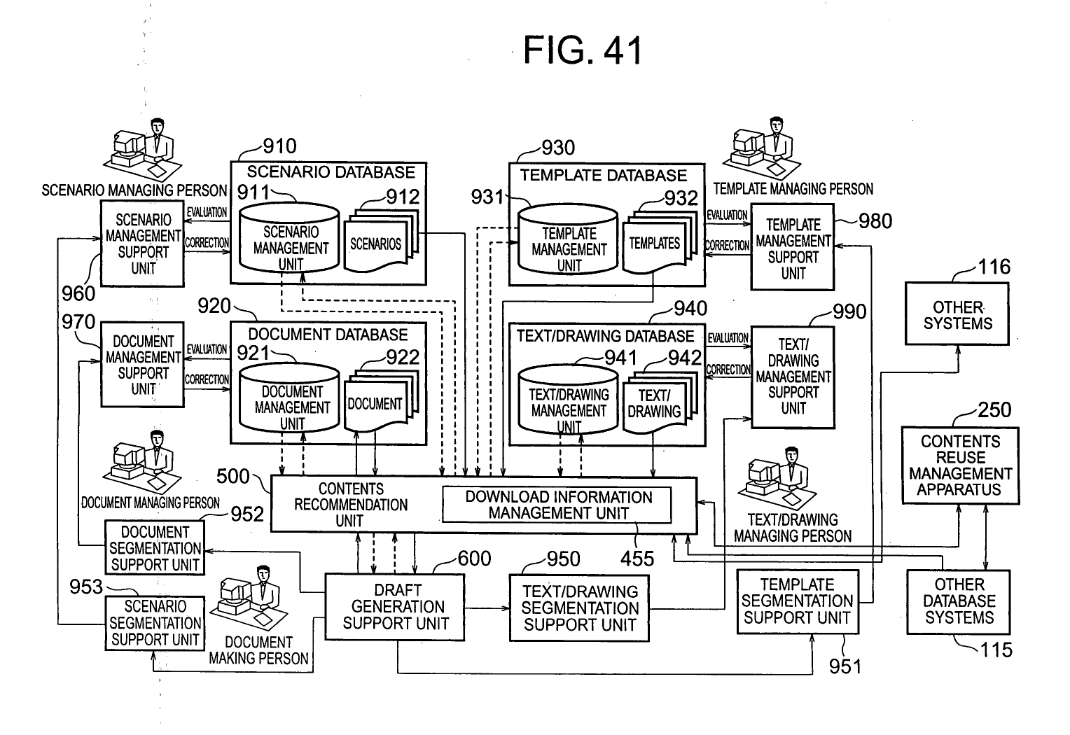

FIG. 41 shows an example of the total system structured by the contents reuse management apparatus and the contents generation support apparatus. A scenario database 910 manages scenarios by the system of the present invention. A document database 920 manages documents (common documents) by the system of the present invention. A template database 930 manages templates by the system of the present invention. A text/drawing sample database 940 manages text/drawing samples by the system of the present invention. A text/drawing sample segmentation support unit 950 obtains common contents for the text/drawing samples as the contents of the contents parts segmentation support unit according to the present invention. A template segmentation support unit 951 obtains common contents for a template as contents of the contents parts segmentation support unit according to the present invention. A document segmentation support unit 952 obtains common contents for a document as contents of the contents parts segmentation support unit according to the present invention. A scenario segmentation support unit 953 obtains common contents for a scenario as contents of the contents parts segmentation support unit according to the present invention.

A scenario management support unit 960 manages a scenario as contents by the contents management support unit according to the present invention. A document management support unit 970 manages a document as contents by the contents management support unit according to the present invention. A template management support unit 980 manages a template as contents by the contents management support unit according to the present invention. A text/drawing sample management support unit 990 manages a text/drawing sample as contents by the contents management support unit according to the present invention.

The contents recommendation unit 500 communicate s with the scenario database 910, the document database 920, the template database 930, and the text/drawing sample database 940 respectively for a scenario, a document, a template, and a text/drawing sample, receives necessary information for generating contents recommendation information, generates recommendation information, and provides the information for the respective databases. The contents recommendation unit 500 generates contents recommendation information according to the information about the reuse relationship, the reuse level, and the user, etc. of the contents generated by the contents reuse management apparatus 250, and provides the information for each database.

A scenario administrator, a document administrator, a template administrator, and a text/drawing sample administrator use the contents recommendation unit 500, refer to the recommendation information, manage contents, and manage generation of contents parts respectively using the scenario management support unit 960, the document management support unit 970, the template management support unit 980, and the text/drawing sample management support unit 990.

The contents reuse management apparatus according to the present invention accesses each database of the contents reuse support apparatus according to the present invention, judges the reuse relationship of contents, and store a judgment result in each database. The contents reuse management apparatus 250 according to the present invention can access the database system 115 and judge the contents reuse relationship. The contents reuse support apparatus according to the present invention can also access another database system 115 to store the contents parts as the contents parts of the database of the contents reuse support apparatus of the present invention. Another system 116 can also access and use the contents database of the contents reuse support apparatus of the present invention.

The contents reuse management apparatus of the present invention can generate surface information based on a plurality of contents, and the reuse relationship can be checked only by comparing the surface information. Since not only the surface information about contents or keyword information, but also meta-data can be used in a reuse judgment, the details of the reuse relationship can be easily judged. Furthermore, since meta-information can be used in making a reuse judgment, all contents in a company can be narrowed among a number of contents in a database, or a similarity can be narrowed to all contents, etc. in a department of a company, thereby realizing a high-speed reuse judgment on a number of contents.

The contents reuse support apparatus according to the present invention can easily select frequently used contents according to the contents recommendation information. Therefore, important contents can be selected and reused to easily generate high quality contents. Thus, by using the contents generation support apparatus of the present invention, the contents of a database can be successfully enhanced.

1. A contents reuse management apparatus for managing contents stored in a database for use with a computer, the apparatus comprising:
first contents to be referred;
second contents to be judged which can be generated by reusing the first contents to be referred;
a reuse judging unit having a surface information generation unit to generate surface information including a character string appearing in contents, and a surface information base reuse judging engine to judge reusability according to the surface information; and
a display unit to display information output by the reuse judging unit.

2. A contents reuse management apparatus for managing contents stored in a database for use with a computer, the apparatus comprising:
first contents to be referred and being able to be reused;
second contents to be judged which can be generated by reusing the first contents to be referred;
a reuse judging unit having a keyword dictionary holding a keyword and a character string, and a dictionary base reuse judging engine to judge the reusability according to dictionary information of the keyword and character string; and
a display unit to display information output by the reuse judging unit.

3. A contents reuse management apparatus for managing contents stored in a database for use with a computer, the apparatus comprising:
first contents to be referred and being able to be reused;
first meta-data including a generating person and a backup source of the first contents to be referred;
second contents to be judged which can be generated by reusing the first contents to be referred;
second meta-data relating to the second contents to be judged;
a surface information generation unit to generate surface information including a character string appearing in a document;
a reuse judging unit having a surface information generation unit to generate surface information including a character string appearing in contents and a surface information base reuse judging engine to judge reusability according to the surface information, or a reuse judging unit having a keyword dictionary holding a keyword and a character string and a dictionary base reuse judging engine to judge the reusability according to dictionary information of the keyword and character string;
a judgment support unit to support a judgment result of the reuse judging unit and using meta-data;
a meta-information dictionary to hold meta-data used by the judgment support unit; and
a display unit to display information output by the reuse judging unit.

4. A contents reuse management apparatus for managing contents stored in a database for use with a computer, the apparatus comprising:
a reference contents database to store a plurality of first contents to be referred and being able to be reused;
second contents to be judged which can be generated by reusing the contents stored in the reference contents database;
a surface information generation unit to generate surface information including a character string appearing in contents;
a reuse judging unit having a surface information generation unit to generate surface information including a character string appearing in contents and a surface information base reuse judging engine to judge reusability according to the surface information, or a reuse judging unit having a keyword dictionary holding a keyword and a character string and a dictionary base reuse judging engine to judge the reusability according to dictionary information of the keyword and character string; and
a display unit to display information output by the reuse judging unit.

5. A contents reuse management apparatus for managing contents stored in a database for use with a computer, the apparatus comprising:
a reference contents database with meta-data to store a plurality of first contents to be referred and being able to be reused and first meta-data of the first contents to be referred;
second contents to be judged which can be generated by reusing the first contents stored in the reference contents database with meta-data;
second meta-data relating to the second contents to be judged;
a reuse judging unit having a surface information generation unit to generate surface information including a character string appearing in contents and a surface information base reuse judging engine to judge reusability according to the surface information, or a reuse judging unit having a keyword dictionary holding a keyword and a character string and a dictionary base reuse judging engine to judge the reusability according to dictionary information of the keyword and character string;
a judgment support unit to support a judgment result of the reuse judging unit and using third meta-data;
a meta-information dictionary to hold the third meta-data used by the judgment support unit; and
a display unit to display information output by the reuse judging unit.

6. A contents reuse management apparatus for judging presence/absence of use in a plurality of contents stored in a database for use with a computer, the apparatus comprising:
a surface information generation unit to generate surface information including a character string appearing in the plurality of contents; and
a reuse judging unit to judge reusability using surface information,
wherein the presence/absence of the use relationship between the plurality of contents is judged depending on a matching level of the surface information between the plurality of contents.

7. A contents reuse management apparatus for judging presence/absence of use in a plurality of contents stored in a database for use with a computer, the apparatus comprising:
a reuse judging unit to generate a keyword contained in the plurality of contents and to judge reusability based on the keyword,
wherein the presence/absence of use relationship of the plurality of contents is judged based on a matching level of a keyword between contents.

8. A contents reuse management apparatus for judging presence/absence of use in a plurality of contents stored in a database for use with a computer, the apparatus comprising:
a surface information generation unit to generate surface information including a character string appearing in the plurality of contents;
at least one of reuse judging unit to judge the presence/absence of a reuse relationship between the plurality of contents according to the surface information, and reuse judging unit to judge reusability based on a keyword;
a meta-data holding unit to hold meta-data which is attribute information about contents; and
a meta-data use judging unit to support a judging result of the reuse judging unit using the meta-data,
wherein a further reuse relationship is judged based on the reuse judgment result of the reuse judging unit and the meta-data.

9. The contents reuse management apparatus according to claim 8,
wherein the meta-data is a contents generation date, and
wherein order of the generation dates of two contents which are judged as having a reuse relationship by the surface information generation unit, to judge which is reusing contents and reused contents of the two contents.

10. A contents reuse management apparatus for judging presence/absence of use in a plurality of contents stored in a database for use with a computer, the apparatus comprising:
a surface information generation unit to generate surface information including a character string appearing in the plurality of contents;
at least one of reuse judging unit to judge the presence/absence of a reuse relationship between contents according to the surface information, and reuse judging unit to judge reusability based on a keyword; and
a meta-information holding unit to hold meta-information which is common information; and
a judgment support unit to judge presence/absence of reuse according to the meta-information,
wherein possibility of reuse of the plurality of contents is judged according to the meta-information, and reuse judging unit makes a reuse judgment according to the surface information or keyword relating to the contents which are judged as possibly reused according to the meta-information.

11. A contents reuse support apparatus for supporting generation of contents stored in a database using a computer, the apparatus comprising:
a contents holding unit to hold a plurality of contents;
a contents management unit to manage use of the plurality of contents by contents management information; and
a contents recommendation unit to generate contents recommendation information indicating usefulness of each of the plurality of contents according to the contents management information from the contents management unit, and to provide the information for a user.

12. The contents reuse support apparatus according to claim 11, further comprising:
a draft generation support unit to support editing the contents.

13. The contents reuse support apparatus according to claim 11, further comprising:
a contents parts segmentation support unit to extract a common portion of the plurality of contents.

14. The contents reuse support apparatus according to claim 11, further comprising:
a contents management support unit to manage each of the plurality of contents as parts, and managing each of the parts according to the use information about the plurality of contents.

15. The contents reuse support apparatus according to claim 11, wherein a correction of contents is managed as a difference between the contents before correction and the contents after correction.

16. The contents reuse support apparatus according to claim 11, wherein the contents recommendation information includes a number of download times of the contents and reusability of the contents.

17. The contents reuse support apparatus according to claim 11, wherein the contents recommendation unit obtains a derivative system of the contents based on the reuse relationship of the contents, and the derivative system is used as the contents recommendation information.

18. The contents reuse support apparatus according to claim 11, further comprising:
contents boundary information generation unit to obtain information about an changed area of contents and an unchanged area adjacent to the changed area of contents, and to generate contents boundary information based on the information,
wherein the contents is managed as a parts based on the contents boundary information.
